(19) United States
(12) Patent Application Publication
(10) Pub. No.: US 2012/0189140 A1
(43) Pub. Date: Jul. 26, 2012

(54) AUDIO-SHARING NETWORK

(75) Inventor: Gregory F. Hughes, Cupertino, CA (US)

(73) Assignee: APPLE INC., Cupertino, CA (US)

(21) Appl. No.: 13/011,465

(22) Filed: Jan. 21, 2011

(51) Int. Cl. H02B 1/00

(52) U.S. Cl. 381/123

(57) ABSTRACT

Systems, methods, and devices for sharing ambient audio via an audio-sharing network are provided. By way of example, a system that receives shared audio from such an audio-sharing network may include a personal electronic device. The personal electronic device may join an audio-sharing network of other electronic devices and receive several audio streams from the audio-sharing network. Based at least partly on these audio streams, the personal electronic device may determine a digital user-personalized audio stream, outputting the digital user-personalized audio stream to a personal listening device. By way of example, the personal electronic device may represent a personal computer, a portable media player, or a portable phone. The personal listening device may represent a speaker of the personal electronic device, a wireless hearing aid, a wireless cochlear implant, a wired hearing aid, a wireless headset, or a wired headset, to name only a few examples.

### BACKGROUND

The present disclosure relates generally to providing an audio stream to a listening device and, more particularly, to providing a personalized ambient audio stream using ambient audio from an audio-sharing network.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In a variety of situations, many people may desire to hear conversations and lectures more clearly. Hearing impaired individuals, for instance, may face difficulties hearing without some amplification and accordingly may wear hearing aids. In general, hearing aids may obtain and amplify ambient audio using microphones in the hearing aids. In certain situations, such as a large group conversation or a lecture, relying on these microphones alone may not allow the hearing aid wearer to participate in the conversation or lecture, because the source of pertinent audio may be located far away or may be obscured by a variety of other nearby sounds.

Various techniques have been developed to enable audio from other microphones to be provided directly to the hearing aids with or without using the microphones in the hearing aids. For example, loop-and-coil systems may transmit audio from a public address (PA) system to all loop-and-coil-equipped hearing aids within an area, and networkable hearing aids may share audio obtained from their respective microphones. These techniques may have several drawbacks. For example, loop-and-coil systems may provide the exact same audio stream to all hearing aids in the area and may require significant capital costs for installation and/or tuning by sound engineer, which may be cost prohibitive to some organizations. Existing networkable hearing aids also may provide essentially the same audio to all hearing aid wearers in such a network, may require additional network hardware, may be cumbersome to join, and/or may allow eavesdropping on conversations by distant devices.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems, methods, and devices for sharing ambient audio via an audio-sharing network. By way of example, a system that receives shared audio from such an audio-sharing network may include a personal electronic device. The personal electronic device may join an audio-sharing network of other electronic devices and receive several audio streams from the audio-sharing network. Based at least partly on these audio streams, the personal electronic device may determine a digital user-personalized audio stream, outputting the digital user-personalized audio stream to a personal listening device. By way of example, the personal electronic device may represent a personal computer, a portable media player, or a portable phone. The personal listening device may represent a speaker of the personal electronic device, a wireless hearing aid, a wireless cochlear implant, a wired hearing aid, a wireless headset, or a wired headset, to name only a few examples.

Various refinements of the features noted above may be found in relation to various aspects of the present disclosure. Further features may also be incorporated in these various aspects as well. These refinements and additional features may be used individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device capable of participating in a listening network, in accordance with an embodiment;

FIG. 2 is a perspective view of a handheld device embodiment of the electronic device of FIG. 1, with associated listening devices, in accordance with an embodiment;

FIG. 3 is a schematic diagram of a listening network formed by several connected electronic devices, in accordance with an embodiment;

FIG. 4 is a flowchart describing an embodiment of a method for obtaining audio through the listening network of FIG. 3;

FIG. 5 is a schematic diagram illustrating the use of a listening network in a university lecture hall, in accordance with an embodiment;

FIG. 6 represents a series of screens that may be displayed on the handheld device of FIG. 2 during a listening network initiation process, in accordance with an embodiment;

FIGS. 7-9 are schematic diagrams of screens that may be displayed on the handheld device of FIG. 2 to cause the handheld device to join a listening network, in accordance with an embodiment;

FIG. 10 is a schematic diagram representing a manner in which an electronic device may securely join a listening network, in accordance with an embodiment;

FIGS. 11-12 are flowcharts describing embodiments of methods for securely joining a listening network, as generally illustrated in FIG. 10;

FIG. 13 is a schematic diagram representing another manner in which an electronic device may securely join a listening network, in accordance with an embodiment;

FIG. 14 is a flowchart describing an embodiment of a method for securely joining a listening network, as generally illustrated in FIG. 13;

FIG. 15 is a schematic diagram of the university lecture hall of FIG. 5, illustrating various audio that may be obtained by electronic devices of the listening network, some of which may be desirable and other which may be noise, in accordance with an embodiment;

FIG. 16 is a schematic diagram of the listening network shown in FIG. 15 showing that the personalized audio provided to a user may include the desirable audio while excluding at least some of the noise, in accordance with an embodiment;

FIGS. 17 and 18 are schematic diagrams of screens that may be displayed on the handheld device of FIG. 2 to enable the handheld device to determine a personalized audio stream, in accordance with an embodiment;

FIG. 19 is a schematic diagram of a screen that may be displayed on the handheld device of FIG. 2 to allow a moderator of the listening network to easily implement network-wide audio settings, in accordance with an embodiment;

FIGS. 20-23 are schematic diagrams of methods for determining whether the handheld device of FIG. 2 transmits audio to a listening network, in accordance with an embodiment;

FIG. 24 is a schematic diagram of a screen that may be displayed on the handheld electronic device of FIG. 2 when the handheld electronic device determines automatically whether to transmit audio to a listening network, in accordance with an embodiment;

FIG. 25 is a flowchart describing an embodiment of a method for determining when to transmit audio to a listening network, in accordance with an embodiment;

FIG. 26 is a schematic diagram representing the use of a listening network in a restaurant setting, in accordance with an embodiment;

FIGS. 27 and 28 represent schematic diagrams of screen that may be displayed on the handheld device of FIG. 2 to join a listening network by tapping the handheld device to another handheld device, in accordance with an embodiment;

FIG. 29 is a schematic diagram representing the use of a listening network in a restaurant setting, in which noise and pertinent audio is present, in accordance with an embodiment;

FIG. 30 is a flowchart describing an embodiment of a method for determining a personalized audio stream that includes pertinent audio obtained from among several audio streams of a listening network;

FIG. 31 is a schematic diagram illustrating the use of a listening network to carry out a teleconference, in accordance with an embodiment;

FIG. 32 is a schematic diagram of a teleconference listening network, in accordance with an embodiment;

FIG. 33 is a schematic diagram illustrating the use of a listening network in a concert setting, in accordance with an embodiment; and

FIG. 34 is a schematic diagram representing a manner of determining spatially compensated audio using audio from various members of a listening network, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned above, many people may desire to hear a lecture, conversation, concert, or other audio that is occurring nearby but is out of earshot. Such users may include hearing impaired individuals that wear hearing aids or other people that may be desire to participate in such a larger conversation or event. Although microphones in hearing aids may amplify sounds occurring nearby, the microphones in the hearing aids may not necessarily detect more distant sounds that are still part of the larger conversation or event that a hearing aid wearer may desire to hear. Likewise, those who do not wear hearing aids may not be able to hear distant sounds that are part of the larger conversation or event.

Alone, a single individual may not be able to hear or detect all parts of a larger conversation or event. Collectively, however, those situated around the larger conversation or event may be able to hear all pertinent sounds. Accordingly, embodiments of the present disclosure relate to systems, methods, and devices for sharing audio via an audio-sharing network of personal electronic devices and/or other networked electronic devices (e.g., networked microphones) in an area. In general, as used herein, the term “audio-sharing network” refers to a network of electronic devices that are local to a common area or common audio source that may share ambient audio that one or more of these electronic devices obtain via associated microphones. The term “personal electronic device” refers herein to an electronic device that generally serves only one user at a time, such as a portable phone.

A personal electronic device in an audio-sharing network may enhance its user's listening experience by receiving audio streams from various locations in the common area or from the common audio source, processing the audio to a personal audio stream using some data processing circuitry, and providing the personal audio stream to a personal listening device (e.g., a hearing aid, headset, or even an integrated speaker of the personal electronic device). As used herein, the term “data processing circuitry” refers to any hardware and/or processor-executable instructions (e.g., software or firmware) that may carry out the present techniques. Furthermore, such data processing circuitry may be a single contained processing module or may be incorporated wholly or partially within any of the other elements within electronic device. A “personalized audio stream” may represent, for example, a combination of some or all of the audio streams shared by the audio-sharing network, some of which may be amplified or attenuated in an effort to provide pertinent audio that is of interest to the user. It should be noted that the terms “pertinent audio” and “audio of interest” in the present disclosure are used interchangeably. By way of example, audio that is pertinent or of interest may include audio that includes certain words or names, that exceeds a threshold volume level, or that derives from a particular member electronic device, to name a few examples.

The systems, methods, and devices disclosed herein may be employed in a variety of settings. The present disclosure expressly describes how an audio-sharing network may be employed in the context of a university lecture setting, a restaurant setting, a teleconference setting, and a concert. It should be appreciated, however, that an audio-sharing network according to the present techniques may be employed in any suitable setting to allow various participants to hear common, but distant or obscured, audio, and that the situations expressly described herein are described by way of example only. For example, when an audio-sharing network is used in a university lecture hall during a lecture, the audio-sharing network may allow those in attendance to more clearly hear the lecturer and/or any questions to the lecturer. Personal electronic devices present in the lecture hall may form an audio-sharing network, collecting and sharing ambient audio, some of which may be pertinent (e.g., the lecturer's comments and/or questions from those in attendance) and some of which may not be pertinent (e.g., murmurs, faint sounds, noise, and so forth). The member devices of the audio-sharing network that provide audio to their respective users may combine and/or process the various audio streams shared by the audio-sharing network to obtain personalized audio streams. In some embodiments, the personalized audio streams may primarily include only the pertinent audio. These personalized audio streams may be provided to their respective users via personal listening devices, such as hearing aids, headsets, or speakers integrated in personal electronic devices.

To prevent eavesdropping by electronic devices that are not located in the general vicinity of the other electronic devices of an audio-sharing network, and/or to easily allow an electronic device to join the audio-sharing network, the present disclosure describes various ways to establish and/or join such an audio-sharing network. For example, in some embodiments, a personal electronic device may only be allowed to join an audio-sharing network (or provide audio from the audio-sharing network to it user, in some embodiments) if location identifying data suggests that the personal electronic device is or is expected to be within the vicinity of the audio-sharing network. As used herein, a personal electronic device may be understood to be “within the vicinity” of the audio-sharing network when ambient audio detectable by the personal electronic device is also detectable by another electronic device of the audio-sharing network. The term “location identifying data” represents digital data that identifies a location of one electronic device relative to at least one other electronic device of an audio-sharing network. Such location identifying data may be used to estimate whether the personal electronic device is within the vicinity of the audio-sharing network. As will be discussed below, such location identifying data may include, for example, a geophysical location provided by location-sensing circuitry of the electronic device, a locally provided password (e.g., an image or text that can be seen by users of member devices of the audio-sharing network), audio ambient to the prospective joining device that is also detectable by another electronic device of the audio-sharing network, or near field communication authentication or handshake data.

The personalized audio stream that may be provided to a listener of the audio-sharing network by the listener's personal electronic device may include primarily pertinent audio from the audio-sharing network that is of interest to the listener, rather than noise that may be in the vicinity of the audio-sharing network. For example, the listener's personal electronic device may determine a personalized audio stream by automatically adjusting the volume levels of various audio streams received from other electronic devices of the audio-sharing network, or may allow the user to select certain audio streams as preferred and therefore amplified. Likewise, the various member devices of the audio-sharing network may not always transmit or receive audio. Rather, the member devices may determine whether to obtain and/or provide ambient audio to the audio-sharing network depending on moderator preferences, whether the member device is in a user's pocket or held in the user's hand, or whether the member device ascertains that the ambient audio is likely to be pertinent to the audio-sharing network (e.g., when a volume level exceeds a threshold, upon hearing the sound of a human voice rather than other sounds, etc.). In certain situations, a personal electronic device may receive various audio streams, some of which may be pertinent and some of which may be noise. The personal electronic device may identify which audio stream(s) may be most pertinent, and may subsequently rely on the other audio streams as a noise basis for any suitable noise reduction techniques.

In addition, it may be appreciated that audio shared by an audio-sharing network may be obtained from a number of electronic devices that all detect substantially similar audio from a common audio source, but these various member devices of the audio-sharing network may be located at different distances from the common audio source. Because sound from the common audio source may reach the different member devices of the audio-sharing network at different times, the shared audio may overlap in time, producing a cacophony of sounds if these audio streams were combined without further processing. As such, in some embodiments, when a personal electronic device determines a personalized audio stream from these various audio streams, the personal electronic device may align the audio streams in time to produce a spatially compensated audio stream. By way of example, such a spatially compensated audio stream may be useful when an audio-sharing network is employed to better hear (or to record) a concert or other such event.

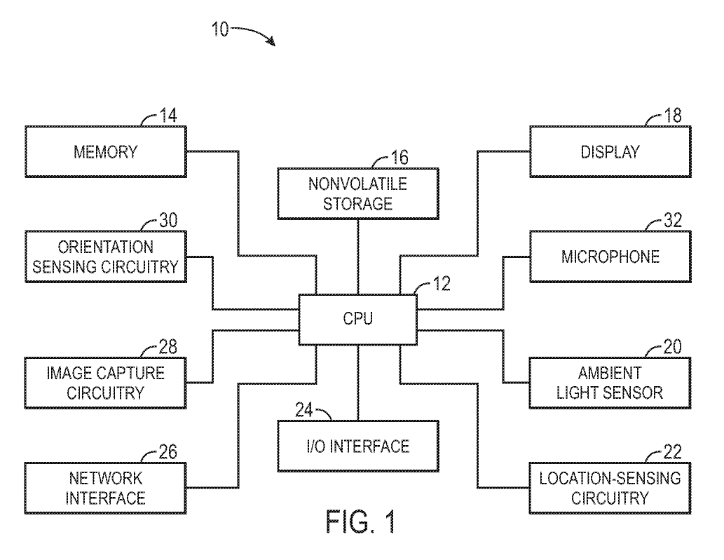

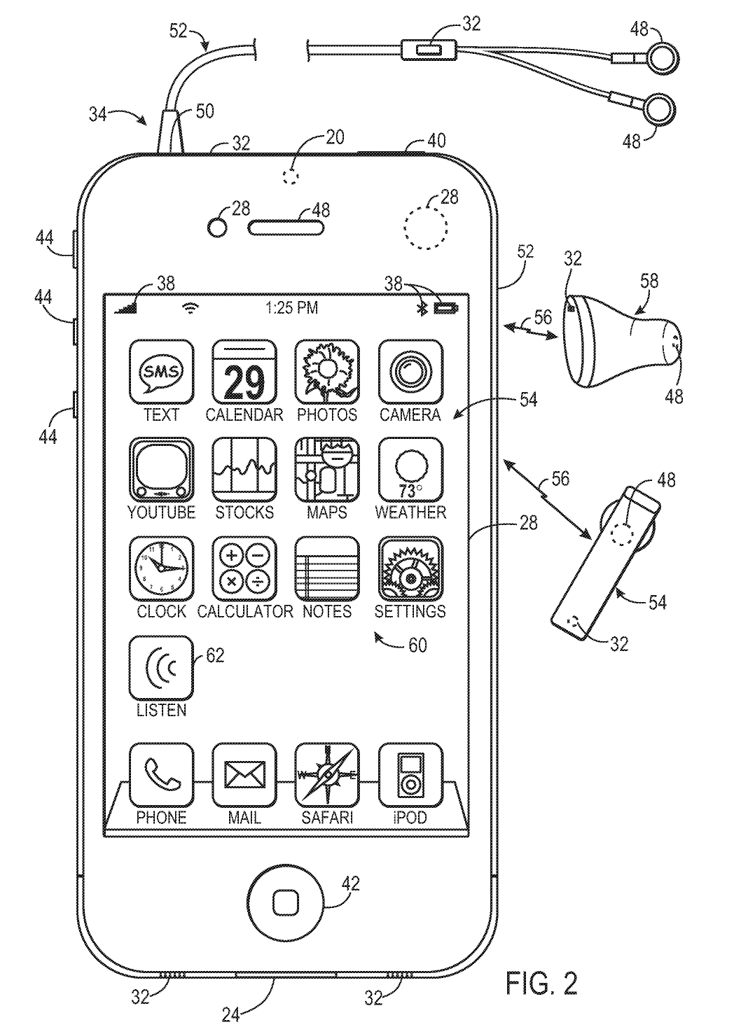

With the foregoing in mind, a general description of suitable electronic devices for performing the presently disclosed techniques is provided below. In particular, FIG. 1 is a block diagram depicting various components that may be present in an electronic device suitable for use with the present techniques. FIG. 2 represents one example of a suitable electronic device, which may be, as illustrated, a handheld electronic device having image capture circuitry, motion-sensing circuitry, and video processing capabilities.

Turning first to FIG. 1, an electronic device 10 for performing the presently disclosed techniques may include, among other things, a central processing unit (CPU) 12 and/or other processors, memory 14, nonvolatile storage 16, a display 18, an ambient light sensor 20, location-sensing circuitry 22, an input/output (I/O) interface 24, network interfaces 26, image capture circuitry 28, orientation-sensing circuitry 30, and a microphone 32. The various functional blocks shown in FIG. 1 may represent hardware elements (including circuitry), software elements (including computer code stored on a computer-readable medium) or a combination of both hardware and software elements. It should further be noted that FIG. 1 is merely one example of a particular implementation and is intended to illustrate the types of components that may be present in electronic device 10.

By way of example, the electronic device 10 may represent a block diagram of the handheld device depicted in FIG. 2 or similar devices. Additionally or alternatively, the electronic device 10 may represent a system of electronic devices with certain characteristics. For example, a first electronic device may include at least a microphone 32, which may provide audio to a second electronic device including the CPU 12 and other data processing circuitry. As noted above, the data processing circuitry may be embodied wholly or in part as software, firmware, or hardware, or any combination thereof. Furthermore, the data processing circuitry may be a single contained processing module or may be incorporated wholly or partially within any of the other elements within electronic device 10. The data processing circuitry may also be partially embodied within electronic device 10 and partially embodied within another electronic device wired or wirelessly connected to device 10. Finally, the data processing circuitry may be wholly implemented within another device wired or wirelessly connected to device 10. To provide one non-limiting example, data processing circuitry might be embodied within a headset in connection with device 10.

In the electronic device 10 of FIG. 1, the CPU 12 and/or other data processing circuitry may be operably coupled with the memory 14 and the nonvolatile memory 16 to perform various algorithms for carrying out the presently disclosed techniques. Such programs or instructions executed by the processor(s) 12 may be stored in any suitable manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions that may be executed by the processor(s) 12 to enable the electronic device 10 to provide various functionalities, including those described herein.

The display 18 may be a flat panel display, such as a liquid crystal display (LCD), with a capacitive touch capability, which may enable users to interact with a user interface of the electronic device 10. The ambient light sensor 20 may sense ambient light to allow the display 18 to be made brighter or darker to match the present ambience. The amount of ambient light may also indicate whether the electronic device 10 is in a user's bag or pocket, or whether the electronic device 10 is in use or is about to be used. Thus, as discussed below, the ambient light sensor 20 may also be used to determine when to share audio with an audio-sharing network of other electronic devices 10. For example, the electronic device 10 may not share audio with the audio-sharing network when the ambient light sensor 20 senses less than a threshold amount of ambient light, which may indicate that the electronic device 10 is in the user's pocket and not in user or about to be used. The location-sensing circuitry 22 may represent device capabilities for determining the relative or absolute geophysical location of electronic device 10. By way of example, the location-sensing circuitry 22 may represent Global Positioning System (GPS) circuitry, algorithms for estimating location based on proximate wireless networks, such as local Wi-Fi networks, and so forth. As discussed below, the location-sensing circuitry 22 may be used to determine location identifying data to verify that the electronic device 10 is within a general vicinity of other electronic devices of an audio-sharing network.

The I/O interface 24 may enable electronic device 10 to interface with various other electronic devices, as may the network interfaces 26. The network interfaces 26 may include, for example, interfaces for near field communication (NFC), a personal area network (PAN) (e.g., a Bluetooth network or an IEEE 802.15.4 network), for a local area network (LAN) (e.g., an IEEE 802.11x network), and/or for a wide area network (WAN) (e.g., a 3G or 4G cellular network). When the electronic device 10 communicates with another electronic device 10 using NFC, the NFC interface of the network interfaces 24 may allow for extremely close range communication at relatively low data rates (e.g., 464 kb/s), complying, for example, with such standards as ISO 18092 or ISO 21521, or it may allow for close range communication at relatively high data rates (560 Mbps), complying, for example, with the TransferJet® protocol. The NFC interface of the network interfaces 24 may have a range of approximately 2 to 4 cm, and the close range communication provided by the NFC interface of the network interfaces 24 may take place via magnetic field induction, allowing the NFC interface to communicate with other NFC interfaces or to retrieve information from tags having radio frequency identification (RFID) circuitry. In some embodiments, the network interfaces 26 may interface with wireless hearing aids or wireless headsets. The network interfaces 24 may allow the electronic device 10 to connect to and/or join an audio-sharing network of other nearby electronic devices 10 via, in some embodiments, a local wireless network. As used herein, the term “local wireless network” refers to a wireless network over which electronic devices 10 joined in an audio-sharing network may communicate locally, without further audio processing or control except for network traffic controllers (e.g., a wireless router). Such a local wireless network may represent, for example, a PAN or a LAN.

The image capture circuitry 28 may enable image and/or video capture, and the orientation-sensing circuitry 30 may observe the movement and/or a relative orientation of the electronic device 10. The orientation-sensing circuitry 30 may represent, for example, one or more accelerometers, gyroscopes, magnetometers, and so forth. As discussed below, the orientation-sensing circuitry 30 may indicate whether the electronic device 10 is in use or about to be used, and thus may indicate whether the electronic device 10 should obtain and/or provide ambient audio to the audio-sharing network. When employed in an audio-sharing network of other electronic devices 10, the microphone 32 may obtain ambient audio that may be shared with the member devices of the audio-sharing network. In some embodiments, the microphone 32 may be a part of another electronic device, such as a wireless hearing aid or wireless headset connected via the network interfaces 24.

FIG. 2 depicts a handheld device 34, which represents one embodiment of electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif.

The handheld device 34 may include an enclosure 36 to protect interior components from physical damage and to shield them from electromagnetic interference. The enclosure 36 may surround the display 18, which may display indicator icons 38. Such indicator icons 38 may indicate, among other things, a cellular signal strength, Bluetooth connection, and/or battery life. The front face of the handheld device 34 may include an ambient light sensor 20 and front-facing image capture circuitry 28. The I/O interfaces 24 may open through the enclosure 36 and may include, for example, a proprietary I/O port from Apple Inc. to connect to external devices. As indicated in FIG. 2, the reverse side of the handheld device 34 may include outward-facing image capture circuitry 28 and, in certain embodiments, an outward-facing microphone 32.

User input structures 40, 42, 44, and 46, in combination with the display 18, may allow a user to control the handheld device 34. For example, the input structure 40 may activate or deactivate the handheld device 34. The input structure 42 may navigate user interface 20 to a home screen, a screen to access recently used and/or background applications or features, and/or to activate a voice-recognition feature of the handheld device 34. The input structures 44 may provide volume control, and the input structure 46 may toggle between vibrate and ring modes. The microphones 32 may obtain ambient audio (e.g., a user's voice) that may be shared among other nearby electronic devices 10 in an audio-sharing network, as discussed further below.

The handheld device 34 may connect to one or more personal listening devices. These personal listening devices may include, for example, one or more of the speakers 48 integrated in the handheld device 34, a wired headset 52, a wireless headset 54, and/or a wireless hearing aid 58. As will be discussed below, when the handheld device 34 is connected to an audio-sharing network, the handheld device 34 may receive and process various audio streams into a personalized audio stream that is sent to such personal listening devices. It should be understood that the personal listening devices shown by way of example in FIG. 2 are not intended to represent an exhaustive representation of all personal listening devices. Indeed, any other suitable personal listening device may be employed, such as wired hearing aids, wired or wireless cochlear implants, and/or non-integrated speakers, to name a few only a few other examples.

By way of example, a headphone input 50 may provide a connection to external speakers and/or headphones. For example, as illustrated in FIG. 2, a wired headset 52 may connect to the handheld device 34 via the headphone input 50. The wired headset 52 may include two speakers 48 and a microphone 32. The microphone 32 may enable a user to speak into the handheld device 34 in the same manner as the microphones 32 located on the handheld device 34. In some embodiments, a button near the microphone 32 may cause the microphone 32 to awaken and/or may cause a voice-related feature of the handheld device 34 to activate. A wireless headset 54 may similarly connect to the handheld device 34 via a wireless connection 56 (e.g., Bluetooth) by way of the network interfaces 26. Like the wired headset 52, the wireless headset 54 may also include a speaker 48 and a microphone 32. Also, in some embodiments, a button near the microphone 32 may cause the microphone 32 to awaken and/or may cause a voice-related feature of the handheld device 34 to activate.

In some embodiments, one or more wireless-enabled hearing aids 58 may connect to the handheld device 34 via a wireless connection 56 (e.g., Bluetooth). Like the wireless headset, the hearing aids 58 also may include a speaker 48 and an integrated microphone 32. The integrated microphone 32 may detect ambient sounds that may be amplified and output to the speaker 48 in most instances. However, in some cases, when the handheld device 34 is connected to the wireless hearing aid 58, the speaker 48 of the wireless hearing aid 58 may only output audio obtained from the handheld device 34. By way of example, the speaker 48 of the wireless hearing aid 58 may receive a personalized audio stream based on audio streams received from an audio-sharing network from the handheld device 34 via the wireless connection 56. While the wireless hearing aid 58 is outputting the personalized audio stream, the microphone 32 of the wireless hearing aid 58 may or may not be collecting additional ambient audio and outputting the additional ambient audio to the speaker 48. In some embodiments, the wireless hearing aid may represent a cochlear implant, which may use electrodes to stimulate the cochlear nerve in lieu of a speaker 48. Additionally or alternatively, a standalone microphone 32 (not shown), which may lack an integrated speaker 48, may interface with the handheld device 34 via the headphone input 50 or via one of the network interfaces 26. Such a standalone microphone 32 may be used to obtain ambient audio to provide to an audio-sharing network of other electronic devices 10.

The handheld device 34 may facilitate access to an audio-sharing network via an audio-sharing network feature of the handheld device 34. By way of example only, as illustrated in FIG. 2, such an audio-sharing network feature may be accessible by selecting an icon 60, such as the icon indicated by numeral 62. By selecting the icon 62, an audio-sharing network feature of the handheld device 34 may be launched or accessed. The audio-sharing network feature of the handheld device 34 may represent, for example, a hardware or machine-executable instruction component of the data processing circuitry of the handheld device 34. By way of example, such a component may be an application program or a component of an operating system of the handheld device 34.

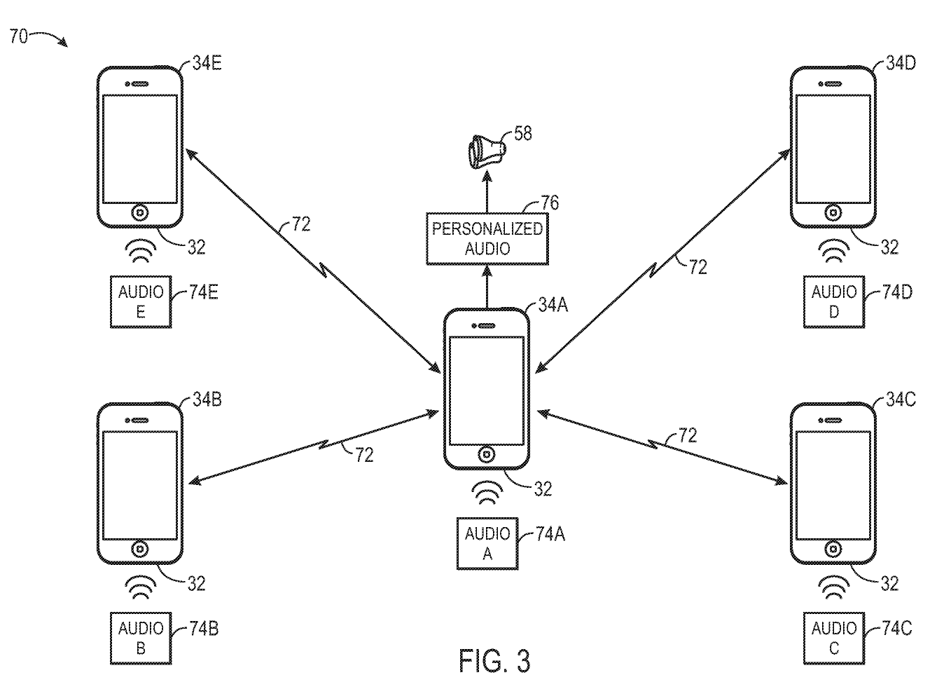

In a variety of settings, a user of an electronic device 10, such as a user whose personal electronic device is the handheld device 34, may desire to more clearly hear sounds that may be faint or out of earshot, but which originate in the same general vicinity of a larger conversation or event. For example, a user may desire to more clearly hear a conversation among several people, lectures and discussions, music from a concert or other event, and so forth. To more clearly hear in these circumstances, the handheld device 34 may be used to form an audio-sharing network 70, as shown in FIG. 3. As shown in FIG. 3, several electronic devices 10, shown here as handheld devices 34A, 34B, 34C, 34D, and 34E, may be wirelessly networked to one other via network connections 72 using any suitable protocol, such as Bluetooth, IEEE 802.15.4, IEEE 802.11x, and so forth, to name a few. Moreover, although the architecture of the audio-sharing network 70 is schematically represented in FIG. 3 to emphasize the network connections 72 between the handheld device 34A and the other handheld devices 34B, 34C, 34D, and 34E of the audio-sharing network 70, any suitable network architecture may be employed. For example, the audio-sharing network 70 may be deployed over a peer-to-peer wireless network and/or any of the handheld devices 34A, 34B, 34C, 34D, and/or 34E of the audio-sharing network 70 may be connected to any others as may be suitable. In addition, one more routers (not shown) may facilitate the network connections 72 between the various handheld devices 34A, 34B, 34C, 34D, and/or 34E, though a central control server may not be necessary.

As shown in FIG. 3, the various handheld devices 34A, 34B, 34C, 34D, and/or 34E of the audio-sharing network 70 may obtain ambient audio from their respective microphones 32. That is, the handheld device 34A may obtain ambient audio 74A, the handheld device 34B may obtain ambient audio 74B, and so forth. Some or all of the handheld devices 34B, 34C, 34D, and/or 34E may transmit their respective audio streams 74B, 74C, 74D, and/or 74E to one another and/or to the handheld device 34A. It should be appreciated that, in FIG. 3 and elsewhere in the present disclosure, audio streams and/or ambient audio shared between the various member electronic devices 10 of the audio-sharing network 70 (e.g., handheld devices 34A, 34B, 34C, 34D, and/or 34E) may be digital representations of ambient audio obtained by respective microphones 32 of the member electronic devices 10. Based at least partly on the audio streams 74B, 74C, 74D, and/or 74E obtained via the audio-sharing network 70, the handheld device 34A may generate a personalized audio stream 76 that may be provided to a personal listening device, such as hearing aids 58. The personalized audio stream 76 may include audio that might otherwise be too distant or faint for the user of the handheld device 34A to hear. Thus, the audio-sharing network 70 shown in FIG. 3 may allow the user of the handheld device 34A to participate in a larger conversation or event that the user might not otherwise be able.

It should be appreciated that while FIG. 3 only depicts that the handheld device 34A provides a personalized audio stream 76 to a personal listening device (e.g., the hearing aids 58), any other member device of the audio-sharing network 70 also may do so. Moreover, the audio-sharing network 70 may alternatively include other personal electronic devices, such as desktop, notebook, or tablet computers or devices, and/or standalone networked microphones. That is, it should be appreciated that the audio-sharing network 70 of FIG. 3 is shown by way of example only, and is not intended to represent all embodiments that the audio-sharing network 70 may take.

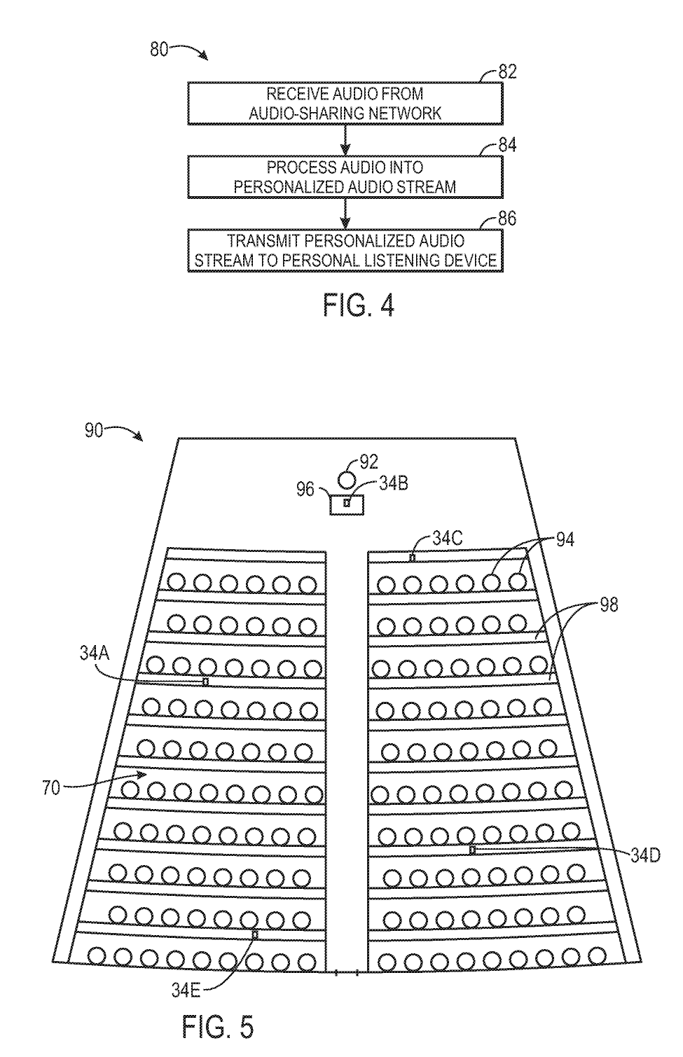

As mentioned above, each of the handheld devices 34A, 34B, 34C, 34D, and/or 34E of the audio-sharing network 70 shown in FIG. 3 may send and/or receive the audio streams 74A, 74B, 74C, 74D, and/or 74E to one another. When an electronic device 10, such as the handheld device 34A, uses the audio streams 74A, 74B, 74C, 74D, and/or 74E to determine a personalized audio stream 76, the handheld device 34A may follow a general method such as that shown by a flowchart 80 of FIG. 4. The flowchart 80 of FIG. 4 may begin when a personal electronic device 10 (e.g., handheld device 34A) receives audio streams from other electronic devices 10 via the audio-sharing network 70 (e.g., audio stream 74B, 74C, 74D, and/or 74E) (block 82). The personal electronic device 10 (e.g., handheld device 34A) may process these audio streams into the personalized audio stream 76 (block 84).

By way of example, the personal electronic device 10 (e.g., handheld device 34A) may determine the personalized audio stream 76 based at least in part on one or more of the audio streams 74B, 74C, 74D, and/or 74E. In some embodiments, the personal electronic device 10 (e.g., handheld device 34A) may apply certain filtering and/or amplifying processing to the received audio streams from the audio-sharing network 70 such that the personalized audio stream 76 may include frequencies that can be heard more clearly by the user of the personal electronic device 10 (e.g., handheld device 34A). Additionally or alternatively, the personal electronic device 10 (e.g., handheld device 34A) may include or exclude certain of the audio streams from the audio-sharing network 70 (e.g., audio streams 74B, 74C, 74D, and/or 74E) to emphasize the audio streams that are most of interest and deemphasize those that may be less pertinent. In one example, when an audio stream contains audio from a primary speaker in a conversation, such as a lecturer in a university lecturer setting, the personal electronic device 10 (e.g., handheld device 34A) may emphasize that particular audio stream by amplifying that stream or attenuating others. In another example, the personal electronic device 10 (e.g., handheld device 34A) may only mix audio streams that have a volume level above a certain threshold or that derive from certain preferred other electronic devices 10 of the audio-sharing network (e.g., handheld devices 34B, 34C, 34D, and/or 34E). Having obtained the personalized audio stream 76, the personal electronic device 10 (e.g., handheld device 34A) may transmit the personalized audio stream 76 to one or more personal listening devices (e.g., a wired headset 52, a wireless headset 54, and/or wireless hearing aids 58) (block 86).

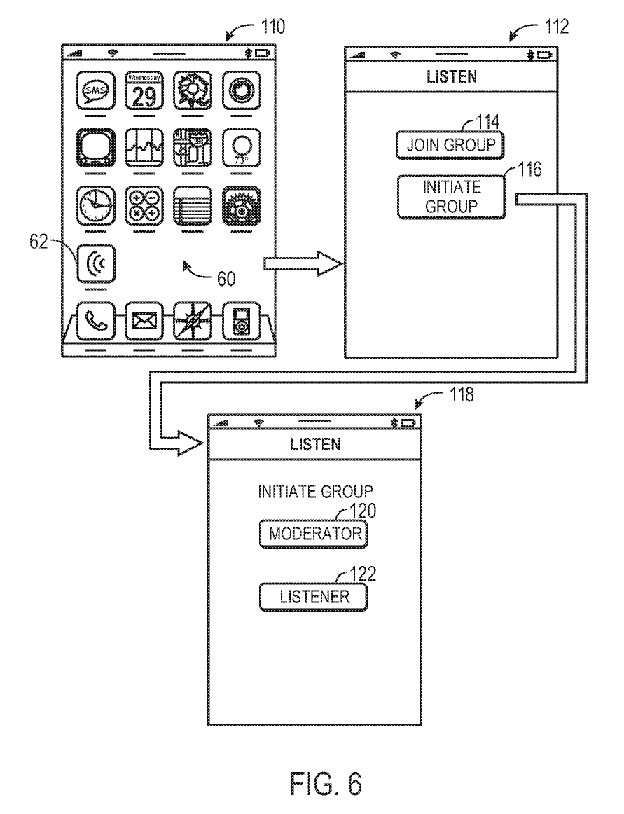

An audio-sharing network, such as the audio-sharing network 70 of FIG. 3, may be employed in a variety of settings. FIG. 5 depicts one such setting, illustrating the use of the audio-sharing network 70 in the context of a university lecture hall 90 setting. In the university lecture hall 90 setting illustrated in FIG. 5, a lecturer 92 stands at the front of the lecture hall 90, which may be filled by a number of seated students 94. The lecturer 92 may have a personal electronic device 10, such as the handheld device 34B, placed on a podium 96 in front of him or her. Some of the students 94 may also have personal electronic devices 10, such as the handheld devices 34A, 34C, 34D, and/or 34E, placed on desks 98 in front of them. The handheld devices 34A, 34B, 34C, 34D, and/or 34E may join together to form an audio-sharing network 70, such as that shown in FIG. 3. In the context of the university lecture hall 90 setting of FIG. 5, the formation of the audio-sharing network 70 among the handheld devices 34A, 34B, 34C, 34D, and/or 34E may allow some of the students 94 to more clearly hear the lecturer 92 and/or any questions from fellow students 94. It should be appreciated that by using the audio-sharing network 70 of the handheld devices 34A, 34B, 34C, 34D, and/or 34E instead of a conventional loop-and-coil system, hearing impaired individuals may be able to hear the lecturer 92 and/or other students 94 even when the lecturer 92 is not using a public address (PA) system.

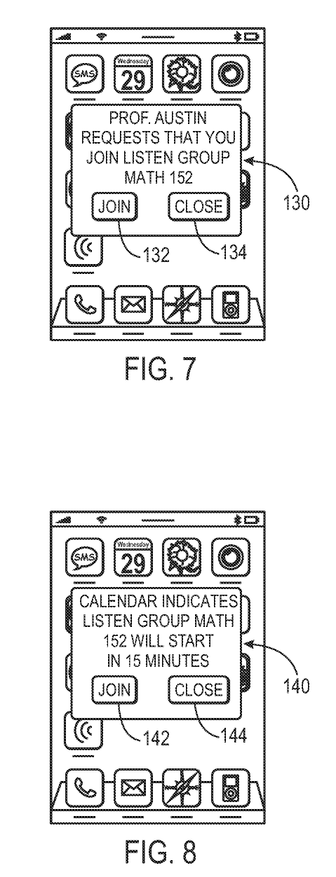

Various manners of in which the audio-sharing network 70 may be employed in the context of the university lecture hall 90 setting of FIG. 5 will now be discussed. In particular, the following discussion of FIGS. 6-25 relate to manners of establishing and operating the audio-sharing network 70 in the context of a university lecture hall 90 setting of FIG. 5. However, it should be appreciated that these manners of establishing and operating the audio-sharing network 70 may also apply to any other suitable context. That is, the discussion that follows uses the university lecture hall 90 setting of FIG. 5 by way of example only, to more clearly explain how various electronic devices 10 may form and use the audio-sharing network 70.

According to the present technique, a user of a personal electronic device 10, such as the handheld devices 34A, 34B, 34C, 34D, and/or 34E may initiate or join an audio-sharing network 70 with other electronic devices 10 with relative ease. For example, as shown in FIG. 6, a user may initiate or join an audio-sharing network by selecting, for example, an icon 60 such as the icon 62 on a home screen 110, which may be displayed on a handheld device 34 (e.g., the handheld device 34A). The icon 62 may launch an audio-sharing network 70 feature of the handheld device 34. As noted above, such an audio-sharing network 70 feature may represent, for example, a hardware or machine-executable instruction component of the data processing circuitry of the handheld device 34. By way of example, such a component may be an application program or a component of an operating system of the handheld device 34.

In the example of FIG. 6, when a user selects the application icon 62 on the home screen 110, the handheld device 34 may display a screen 112. The screen 112 may display an option to join an existing audio-sharing network 70, as shown by a selectable button 114 labeled “Join Group,” or may enable the user to initiate a new audio-sharing network 70, as indicated by a selectable icon 116, labeled “Initiate Group.” Selecting, for example, the selectable icon 116 may cause the handheld device 34 to display a screen 118 to initiate an audio-sharing network 70 with other nearby electronic devices 10. The screen 118 may include, for example, a selectable buttons 120 and 122, respectively labeled “Moderator” and “Listener.” Selecting the selectable button 120 labeled “Moderator” may initiate an audio-sharing network 70 with the user of the handheld device 34 as the moderator. As used herein, the electronic device 10 that is used by a moderator is referred to as a “moderating electronic device” of an audio-sharing network 70, and, as discussed below, such a moderating electronic device 10 may control certain global operational settings of the audio-sharing network 70. The selection of the selectable button 122 may initiate an audio-sharing network 70 with the user of the handheld device 34 serving only as a participant in the audio-sharing network 70. The “listener” may not control such global operational settings of the audio-sharing network 70. It should further be appreciated that not all audio-sharing networks 70 need have a moderator. Indeed, some audio-sharing networks 70 may have no moderator and some audio-sharing networks 70 may have more than one moderator.

A moderator of a newly initiated audio-sharing network 70 may invite certain electronic devices 10 to join the audio-sharing network 70. For example, the electronic devices 10 that may be invited to join the audio-sharing network 70 may be limited, for example, to those electronic devices in the general vicinity of the moderator's electronic device 10. Continuing with the example of the university lecture hall 90 setting of FIG. 5, the lecturer 92 may initiate an audio-sharing network 70, inviting those electronic devices 10 within the university lecture hall 90 setting to join the audio-sharing network 70. For example, the lecturer 92 may invite the handheld devices 34A, 34C, 34D, and/or 34E to join the audio-sharing network 70 that the lecturer 92 has initiated. By way of example, the lecturer 92 may invite the handheld electronic devices 34A, 34C, 34D, and/or 34E to join the audio-sharing network 70 based on their physical proximity to the handheld device 34B belonging to the lecturer 92. For example, only the electronic devices 10 that are within a certain distance from the moderating electronic device 10 or other electronic devices 10 of the audio-sharing network 70 may be invited. The electronic devices 10 may be invited based, for example, on a personal area network (PAN) signal strength, the accessibility of the handheld devices 34A, 34C, 34D, and/or 34E through the same wireless LAN, by text messaging or emailing invitations only to the handheld electronic devices 34A, 34C, 34D, and/or 34E, by tapping near field communication (NFC) interfaces of the electronic devices 10 together, and so forth.

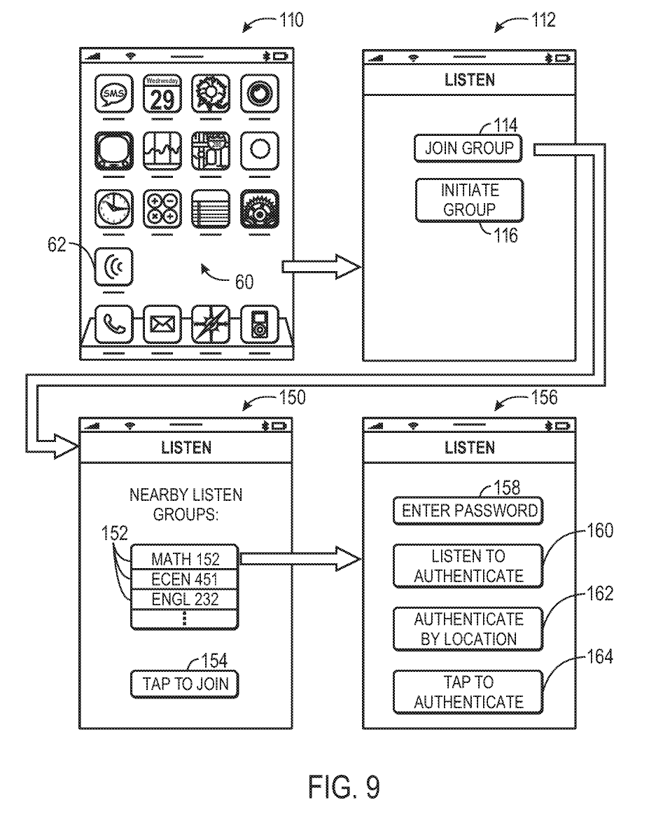

By way of example, as shown in FIG. 7, a pop-up box 130 may be caused to appear on the handheld devices 34A, 34C, 34D, and/or 34E when the lecturer 92 invites the handheld devices 34A, 34C, 34D, and/or 34E to join the audio-sharing network 70. The pop-up box 130 may indicate that the lecturer 92 (e.g., Prof. Austin) has requested that the receiving device join the audio-sharing network 70 for the day's class (e.g., Math 152), and thus may include a selectable button 132 labeled “Join,” and a selectable button 134, labeled “Close.” In some embodiments, the invitation to join the audio-sharing network 70 may cause the invited handheld devices 34A, 34C, 34D, and/or 34E to record a calendar reminder to join the audio-sharing network 70. For example, as shown in FIG. 8, when the time approaches for such an audio-sharing network 70 to form, the handheld device 34A, 34C, 34D, and/or 34E may display a pop-up box 140 indicating that the user's participation in the audio-sharing network 70 is requested. The pop-up box 140 may appear, for example, when a class occurring in the university lecture hall 90 setting is scheduled to begin. Thus, the pop-up box 140 may also include a selectable button 142 labeled “Join,” and a selectable button 144, labeled “Close.”

Another manner of joining the audio-sharing network 70 may involve navigating through a series of screens that may be displayed on the handheld device 34 to select the name of the audio-sharing network 70, as shown in FIG. 9. In FIG. 9, a user may select the icon 62 on the home screen 110 to cause the handheld device 34 to display the screen 112. To join an existing audio-sharing network 70, the user may select the selectable button 114 labeled “Join Group.” When the user selects the selectable button 114, the handheld device 34 may display a screen 150 with a listing 152 of nearby audio-sharing networks 70. The user may select the desired audio-sharing network 70 from the listing 152. Thereafter, the user may be permitted to join the audio-sharing network 70 after verifying that the handheld device 34 is in the vicinity of the other electronic devices 10 of the audio-sharing network 70. In the context of the university lecture hall 90 setting of FIG. 5, for example, such verification or authentication may involve verifying that the prospective joining handheld device 34A, 34C, 34D, and/or 34E is present within the lecture hall 90.

Various ways of verifying that the prospective joining handheld device 34A, 34C, 34D, and/or 34E is in the vicinity of the other electronic devices 10 of the audio-sharing network 70 appear on a screen 156, which may be displayed on the handheld device 34 when an audio-sharing network 70 is selected from the listing 152 on the screen 150. Each of the various ways of authenticating that the handheld device 34 is located within the vicinity of the audio-sharing network 70 may involve using some location identifying data that indicates the handheld device 34 is or is expected to be located within range of detecting at least some sounds also detectable to other electronic devices 10 of the audio-sharing network 70. As such, the screen 156 may display a selectable button 158 labeled “Enter Password,” a selectable button 160 labeled “Listen to Authenticate,” a selectable button 162 labeled “Authenticate by Location,” and a selectable button 164 labeled “Tap to Authenticate.” In particular, the selectable button 158, labeled “Enter Password,” may allow the user to authenticate the handheld device 34 to join the audio-sharing network 70 by entering or capturing an image of a password. The selectable button 160, labeled “Listen to Authenticate,” may allow the user to authenticate the handheld device 34 to join the audio-sharing network 70 when the handheld device 34 detects sounds present in the ambient audio detected by the audio-sharing network 70. The selectable button 162, labeled “Authenticate by Location,” may allow the user to authenticate the handheld device 34 to join the audio-sharing network 70 when the geophysical location of the handheld device 34 is generally the same as the electronic devices 10 of the audio-sharing network 70. The selectable button 164, labeled “Tap to Authenticate,” may allow the user to authenticate the handheld device 34 to join the audio-sharing network 70 when an NFC-enabled embodiment of the handheld device 34 is tapped to another NFC-enabled electronic device 10 that is an existing member of the audio-sharing network 70. More or fewer such authentication methods may be employed to prevent eavesdropping. For example, some audio-sharing networks 70 may not allow the authentication method provided when a user selects the selectable button 164 labeled “Tap to Authenticate.” Likewise, other audio-sharing networks 70 may require multiple authentication methods. Also, although not expressly indicated in the example of FIG. 9, it should be appreciated that some audio-sharing networks 70 may employ authentication via a public/private key pair or a password and a public encryption key.

When the user selects the selectable button 160, labeled “Enter Password,” the handheld device 34 may allow the user to enter a password associated with the audio-sharing network 70. The password may be set by the lecturer 92 for example, and remain the same each time the lecturer 92 initiates the audio-sharing network 70 using the handheld device 34B, or may vary as desired. For example, the lecturer 92 may change the password each time the lecturer is in session, writing the password on a whiteboard in front of the students 94 or emailing and/or text messaging the password to the students 94. When the password supplied by the prospective joining personal electronic device 10, such as the handheld device 34A, 34C, 34D, and/or 34E matches the password provided by the lecturer 92, the handheld device 34A, 34C, 34D, and/or 34E may be allowed to join the audio-sharing network 70. In another embodiment, selecting the selectable button 160 labeled “Enter Password” may allow the user to capture an image of a password (e.g., an alphanumeric password or a linear or matrix barcode). When the image captured by the handheld device 34 includes the expected password, the handheld device 34 may be permitted to join the audio-sharing network 70. The entered password or image of the password may represent location identifying data that may be used to verify that the handheld device 34 is located within the vicinity of the audio-sharing network 70.

Selecting the selectable button 162, labeled “Authenticate by Location,” may allow the prospective joining handheld device 34A, 34C, 34D, and/or 34E to join the audio-sharing network 70 by verifying that its absolute or relative geophysical position is sufficiently near to other electronic devices 10 in the audio-sharing network 70. For example, to join the audio-sharing network 70, the prospective joining handheld device 34A, 34C, 34D, and/or 34E may determine and/or provide its current geophysical position as determined by the location-sensing circuitry 22 to another electronic device 10 of the audio-sharing network 70. By way of example, if the geophysical position of the prospective joining handheld device 34A, 34C, 34D, and/or 34E is within a threshold distance from the handheld device 34B of the lecturer 92, or within a threshold distance from any other electronic device 10 belonging to the audio-sharing network 70, or within a selected boundary (e.g., within the lecture hall 90), the prospective joining device 34A, 34C, 34D, and/or 34E may be permitted to join the audio-sharing network 70. The geophysical location of the handheld device 34 may represent location identifying data that may be used to verify that the handheld device 34 is located within the vicinity of the audio-sharing network 70.

When the user selects the selectable button 164, labeled “Tap to Authenticate,” the handheld device 34 may allow the user to authenticate the handheld device 34 by tapping another handheld device 34 that is a member of the audio-sharing network 70, when both of these handheld devices 34 are NFC-enabled. For example, after selecting the selectable button 164, a prospective joining handheld device 34A, 34C, 34D, and/or 34E may be tapped to the handheld device 34B, which may be a member of the audio-sharing network 70. An NFC handshake may occur, producing data that indicates that the prospective joining handheld device 34A, 34C, 34D, and/or 34E is within close range to the handheld device 34B (e.g., 2-4 cm). The prospective joining handheld device 34A, 34C, 34D, and/or 34E is thus clearly within the vicinity of the audio-sharing network 70. As such, the NFC handshake data may represent location identifying data that may be used to verify that the handheld device 34 is located within the vicinity of the audio-sharing network 70.

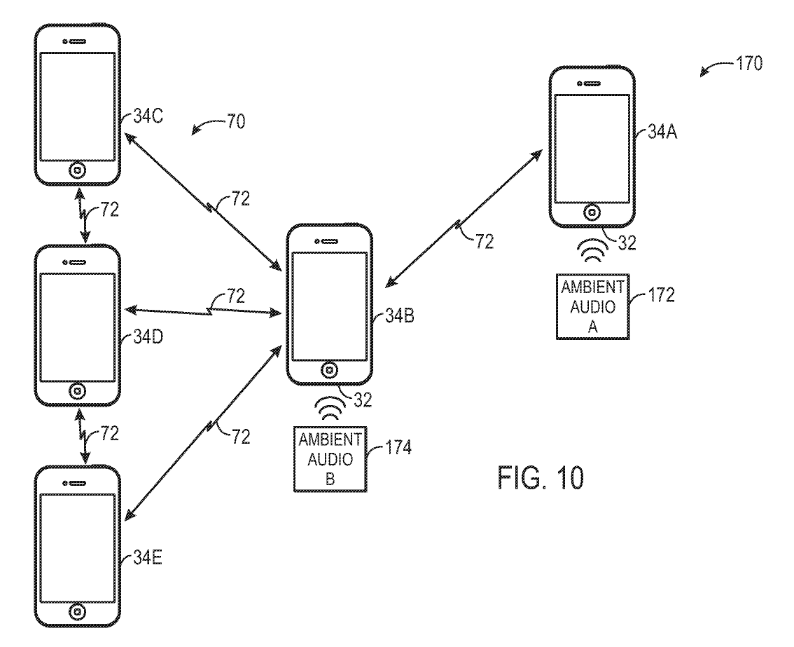

Selecting the selectable button 160, labeled “Listen to Authenticate,” may allow the handheld device 34 to join the audio-sharing network 70 based at least partly on the presence of similar sounds detectable both to the prospective joining handheld device 34 and the other members of the audio-sharing network 70. Various ways of verifying that the handheld device 34 is within the vicinity of the audio-sharing network 70 using similarities in ambient audio detected by the prospective and member devices of the audio-sharing network 70 are discussed below with reference to FIGS. 10-14. In particular, a prospective joining handheld device 34 may be or may be expected to be within the vicinity of the audio-sharing network 70 when similar sounds are present in the ambient audio detected by the prospective and member devices of the audio-sharing network 70. As such, ambient audio or information detected in ambient audio may also represent location identifying data that may be used to verify that the handheld device 34 is located within the vicinity of the audio-sharing network 70.

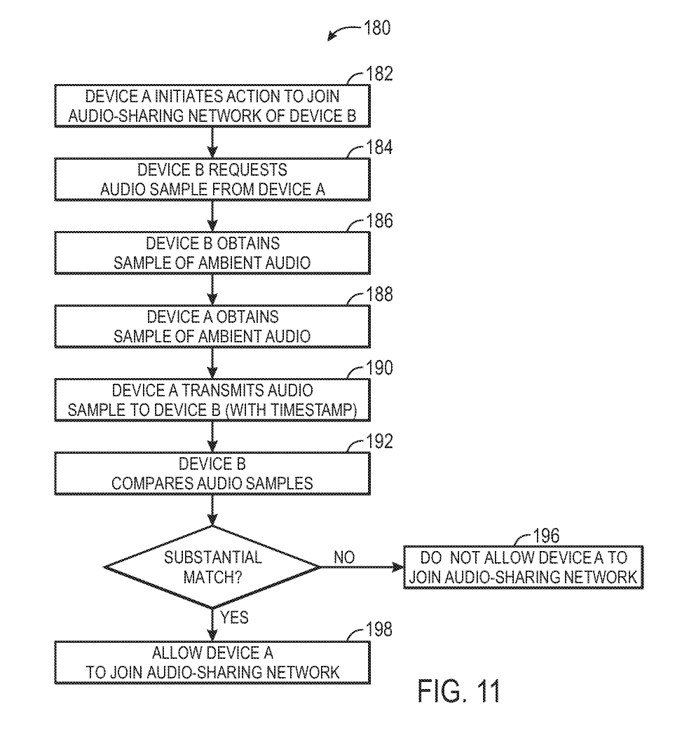

For the above cases in which the selectable buttons 158, 160, 162, and/or 164 are selected to authenticate the handheld device 34, the location identifying data that is generated may be used in various ways to verify that the handheld device 34 is within the vicinity of the audio-sharing network 70. In some embodiments, the location identifying data may be provided to other electronic devices 10 of the audio-sharing network (e.g., handheld device 34B), which may compare the location identifying data provided by the prospective joining handheld device 34 with its own location identifying data. One specific way of using location identifying data to authenticate a prospective joining handheld device 34 is described below with reference to FIG. 11. In other embodiments, the prospective joining handheld device 34 may self-authenticate by comparing its location identifying data to that of other member devices of an audio-sharing network 70. One specific way of such self-authentication is described below with reference to FIG. 12. Although the location identifying data referred to in FIGS. 11 and 12 is represented by ambient audio, it should be appreciated that any other suitable location identifying data, such as the entered password or image of the password, the geophysical location, or the NFC handshake data, may be used in its place.

FIGS. 10-14 relate to ways of authenticating a prospective joining electronic device 10 (e.g., handheld device 34A) that may desire to join an audio-sharing network of another electronic device 10 (e.g., handheld device 34B). As shown in FIG. 10, such an authentication process 170 may involve a prospective joining handheld device 34A that is attempting to join an audio-sharing network 70 that includes the handheld device 34B. By way of example, the handheld device 34A may belong to a student 94 in the lecture hall 90 of FIG. 5, and the handheld device 34B may belong to the lecturer 92. To prevent eavesdropping on the audio-sharing network 70 of which the handheld device 34B is a member, the prospective joining handheld device 34A may establish a network connection 72 with the handheld device 34B, over which the handheld devices 34A and 34B may respectively exchange ambient audio A 172 and ambient audio B 174. In FIG. 10, the handheld device 34B is shown to be obtaining the ambient audio B 174, but it should be appreciated that any other member device of the audio-sharing network 70 (e.g., handheld devices 34C, 34D, and/or 34E) may also detect ambient audio signals that may be used to authenticate the prospective joining handheld device 34A. Also, it should be appreciated that any of the handheld devices 34B, 34C, 34D, and/or 34E may or may not be connected to one another or to the handheld device 34A via a network connection 72. Indeed, any suitable network architecture may be employed.

As illustrated by a flowchart 180 of FIG. 11, the ambient audio A 172 and ambient audio B 174 may be used to verify that the handheld device 34A is within the vicinity of the audio-sharing network 70. The flowchart 180 of FIG. 11 may begin when the handheld device 34A initiates some action to join the audio-sharing network 70 of handheld device 34B (block 182). By way of example, the handheld device 34A may establish the network connection 72 to the handheld device 34B and may ask to join the audio-sharing network 70 to which the handheld device 34B is a member. Thereafter, the handheld device 34B may request an audio sample from the handheld device 34A (block 184). Meanwhile, the handheld device 34B may obtain the sample of the ambient audio B 174 (block 186) while the handheld device 34A obtains the ambient audio A 172 (block 188).

The handheld device 34A may transmit to the handheld device 34B a sample of the ambient audio A 172 with a time stamp or some indication of when the ambient audio A 172 was obtained (block 190). The handheld device 34B then may compare the ambient audio A 172 to the ambient audio B 174 (block 192). If the handheld device 34B determines that no sounds in the ambient audio A 172 and the ambient audio B 174 substantially match one another (decision block 194), it may be inferred that the handheld device 34A is not located in the vicinity of the handheld device 34B. Thus, the handheld device 34B may not allow the handheld device 34A to join the audio-sharing network 70 (block 196). If the handheld device 34B determines that at least some sounds in the ambient audio A 172 and the ambient audio B 174 do substantially match (decision block 194), it may be inferred that the handheld device 34A is within the vicinity of the audio-sharing network 70 to which the handheld device 34B is a member. Thus, the handheld device 34B may permit the handheld device 34A to join the audio-sharing network 70 (block 198).

Additionally or alternatively, the handheld device 34A may self-authenticate to join the audio-sharing network 70, as shown by a flowchart 210 of FIG. 12. The flowchart 210 of FIG. 12 may begin when the handheld device 34A forms the network connection 72 with the handheld device 34B, and is tentatively permitted to join the audio-sharing network 70 (block 212). While the handheld device 34A tentatively joins audio-sharing network 70, the audio-sharing network 70 may provide shared audio (e.g., audio streams 74A, 74C, 74D, and/or 74E) to the handheld device 34A, but the handheld device 34A may not yet provide these audio streams to the user. Rather, the handheld device 34A may first verify that at least some sounds in the shared audio from the audio-sharing network 70 match sounds ambient to the handheld device 34A.

As such, the handheld device 34A may obtain the ambient audio A 172 (block 214), comparing the ambient audio A 172 to one or more audio streams from the audio-sharing network 70, such as the ambient audio B 174 (block 216). If the handheld device 34A determines that no sounds in the ambient audio A 172 substantially match sounds in the ambient audio B 174 (decision block 218), it may be inferred that the handheld device 34A is not present in the vicinity of the audio-sharing network 70. Thus, the handheld device 34A may exit the audio-sharing network 70 (block 220). If at least some sounds in the ambient audio A 172 substantially match sounds in the ambient audio B 174, it may inferred that the handheld device 34A is located in the vicinity of the audio-sharing network 70 (decision block 218). Thus, the handheld device 34A may begin to provide the audio streams from the audio-sharing network 70 to the user of the handheld device 34A (block 222).

With regard to the above discussion relating to FIGS. 10-12, it should be understood that the authentication procedures may take place between the prospective joining electronic device 10 (e.g., handheld device 34A) and at least one member electronic device 10 of the audio-sharing network 70 (e.g., handheld device 34B). That is, in some embodiments, the authentication processes discussed above may also involve any other member electronic devices 10 of the audio-sharing network (e.g., handheld device 34C, 34D, and/or 34E). For example, if matching sounds are not found between ambient audio from the prospective joining electronic device 10 (e.g., handheld device 34A) and a first member electronic device 10 of the audio-sharing network 70 (e.g., handheld device 34B), the prospective joining electronic device 10 (e.g., handheld device 34A) may be authenticated by a second member electronic device 10 of the audio-sharing network 70 (e.g., handheld device 34C). Likewise, in some embodiments, the prospective joining electronic device 10 (e.g., handheld device 34A) may be authenticated by multiple member electronic devices 10 of an audio-sharing network 70 in parallel (e.g., both handheld devices 34B and 34C), and may be allowed to join if sounds from ambient audio obtained by the various devices match with that of at least one of the multiple member electronic devices 10.

Consider, for example, a situation in which the handheld devices 34A, 34C, and 34B may be located along a line, each spaced approximately 15 feet apart. When the handheld device 34B obtains the ambient audio B 174 and the handheld device 34A obtains the ambient audio 172, the distance between them may be too great for much overlapping sounds. When sounds from ambient audio streams respectively obtained by the handheld devices 34A and 34B do not substantially match, the handheld device 34A may not join the audio-sharing network 70, as noted above. Rather, the authentication process may repeat, this time based on ambient audio obtained by the handheld device 34C rather than the handheld device 34B. Because, in the instant example, the handheld device 34A is nearer to the handheld device 34C than the handheld device 34B, the ambient audio obtained by the handheld devices 34A and 34C may include overlapping sounds. Thus, the handheld device 34A may subsequently join the audio-sharing network 70 of the handheld devices 34B and 34C, even though initially the authentication process may have failed.

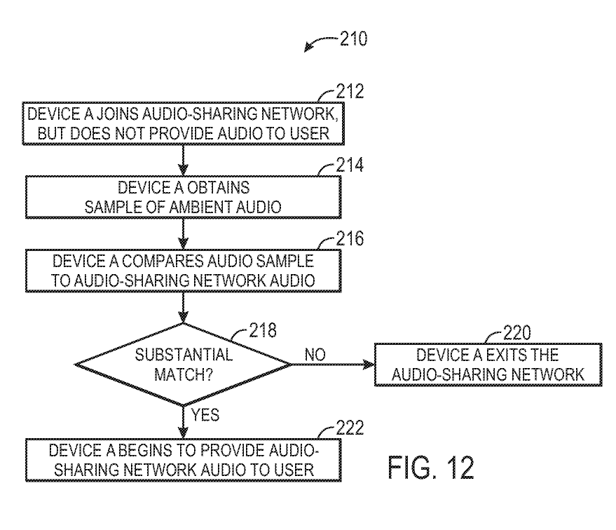

In some embodiments, as shown in an authentication process 230 of FIG. 13, an audio security code 232 may be used to verify the location of the prospective joining handheld device 34A. In particular, as illustrated in FIG. 13, when the prospective joining handheld device 34A establishes a connection 72 to the handheld device 34B, the handheld device 34B may emit an audio security code. The audio security code 232 may be certain sounds that are audible to humans or ultrasonic and inaudible to humans. The handheld device 34A may be permitted to join the audio-sharing network 70 when the handheld device 34A is close enough to the handheld device 34B to detect the audio security code 232.

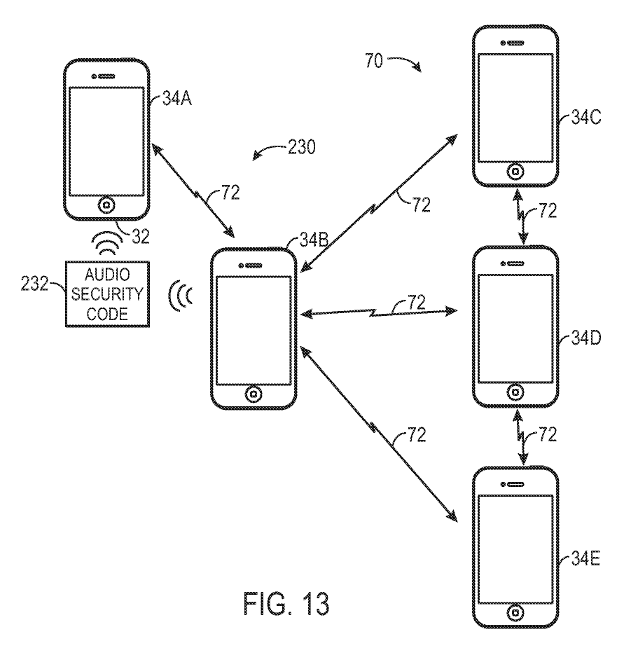

For example, as described by a flowchart 240 of FIG. 14, the handheld device 34B may authenticate the handheld device 34A, determining that he handheld device 34A is in the vicinity of the audio-sharing network 70, based on whether the handheld device 34A can detect the audio security code 232. The flowchart 240 may begin when the handheld device 34A initiates some action to join the audio-sharing network 70 to which the handheld device 34B belongs (block 242). By way of example, the handheld device 34A may establish a network connection 72 to the handheld device 34B, and ask to join the audio-sharing network 70.

The handheld device 34B may request an audio sample from the handheld device 34A (block 244) while emitting the audio security code 232 (block 246). By way of example, the audio security code may be a series of sounds that may be detectable to those electronic devices 10 substantially within the vicinity of the audio-sharing network 70. In some embodiments, the audio security code 232 may be ultrasonic and inaudible to humans. The handheld device 34A may detect ambient audio from its microphone 32 (block 248), transmitting the ambient audio to the handheld device 34B with a timestamp indicating when the handheld device 34A obtained the ambient audio (block 250). Additionally or alternatively, the handheld device 34A may ascertain information indicated by the audio security code 232 itself (e.g., a password or number), and provide data associated with the audio security code to the handheld device 34B.

The handheld device 34B may compare the audio sample from the handheld device 34A with the audio security code 232 that the handheld device 34B previously emitted (block 252). If the audio security code 232 is not discernable in the audio sample provided by the handheld device 34A (decision block 254), the handheld device 34B may not allow the handheld device 34A to join the audio-sharing network 70 (block 256). If the audio security code 232 is discernable in the audio sample provided by the handheld device 34A (decision block 254), the handheld device 34B may allow the handheld device 34A to join the audio-sharing network 70 (block 258).

Once an electronic device 10 has joined an audio-sharing network 70, the electronic device 10 may determine a personalized audio stream 76 to provide to a personal listening device (e.g., hearing aids 58). If the personalized audio stream 76 were always simply a combination of all of the audio streams obtained by other members of the audio-sharing network 70, (e.g., handheld device 34B, 34C, 34D, and/or 34E), the personalized audio stream 76 might include undesirable audio that detracts from, rather than enhances, the user's listening experience. As such, in some embodiments, an electronic device 10 that is a member of an audio-sharing network 70 (e.g., the handheld device 34A), may combine certain audio streams of the audio-sharing network 70 in a manner that can enhance the user's listening experience. Additionally or alternatively, other member devices of the audio-sharing network 70 (e.g., the handheld device 34B, 34C, 34D, and/or 34E) may not always transmit ambient audio to the other member of the audio-sharing network 70.

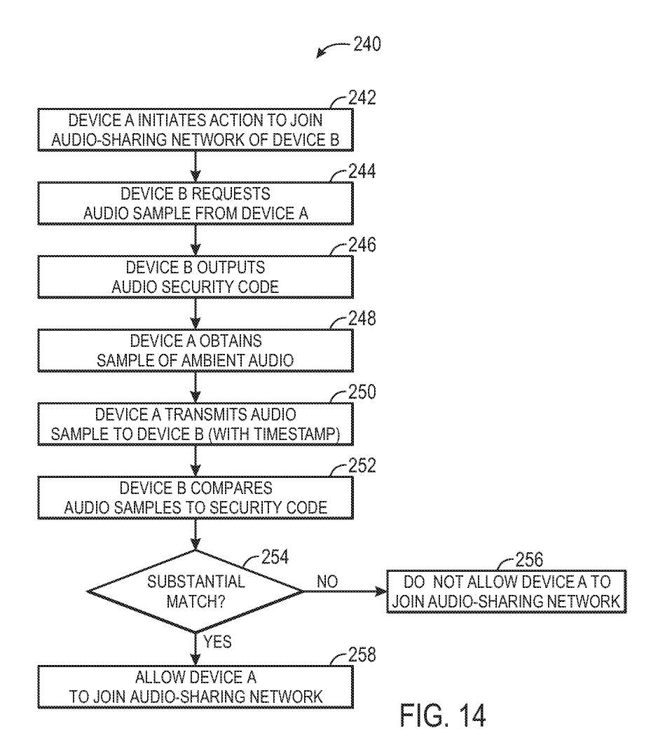

For example, as shown in FIG. 15, many sounds may be present in the university lecture hall 90 setting, only some of which may be desirable to students 94 sitting in the lecture. For example, a student 94 in the back of the lecture hall may ask a question 270, to which the lecturer 92 may respond with an answer 272. Although the students 94 may primarily desire to hear the question 270 and the answer 272, other sounds may be present, such as random noise 274, a murmur 276, and/or other faint sounds 278.

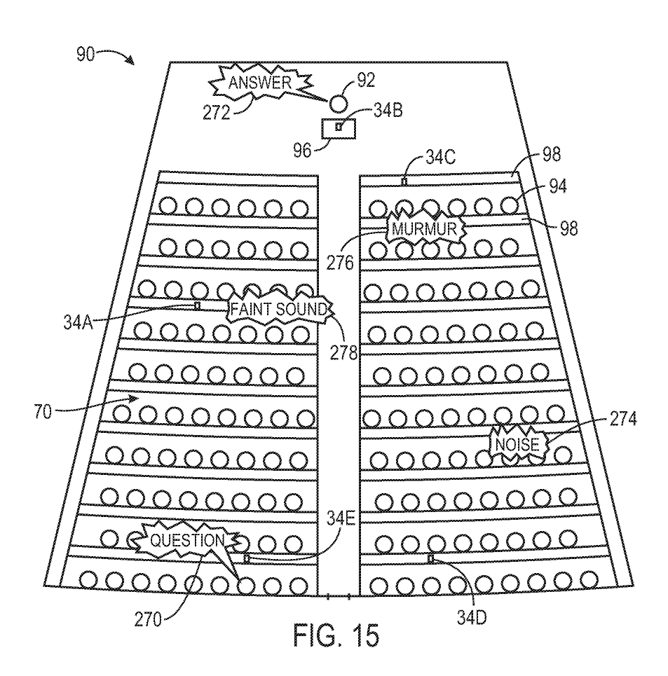

As shown in FIG. 16, the audio-sharing network 70 formed between the handheld devices 34A, 34B, 34C, 34D, and/or 34E may be near enough to obtain ambient audio that includes these various sounds 270, 272, 274, 276, and/or 278. From the audio streams provided by the various member devices of the audio-sharing network 70, the handheld device 34A may determine the personalized audio stream 76. In some embodiments, the personalized audio stream may primarily include the question 270 and the answer 272, and may largely exclude the noise 274, the murmur 276, and the faint sounds 278. As shown in FIG. 16, the personalized audio stream 76 may be output to a personal listening device, such as the hearing aids 58.

In the example of FIG. 16, the handheld device 34A is shown to determine the personalized audio 76 to include primarily audio that is likely to be of interest to its listener. In some embodiments, the handheld device 34A may determine the personalized audio stream 76 by varying the volume levels of the audio streams received via the audio-sharing network 70, or by including or excluding certain of the audio streams received via the audio-sharing network 70. That is, in some embodiments, the handheld device 34A may determine the personalized audio stream based at least in part on user preferences. Additionally or alternatively, the individual member devices 34A, 34B, 34C, 34D, and/or 34E themselves may only provide their respective audio steams when such audio is expected to be pertinent. Indeed, in some embodiments, the member electronic devices 10 of the audio-sharing network 70 may share or not share ambient audio detectable to the member electronic devices 10 based at least partly on the behavior of their respective users.

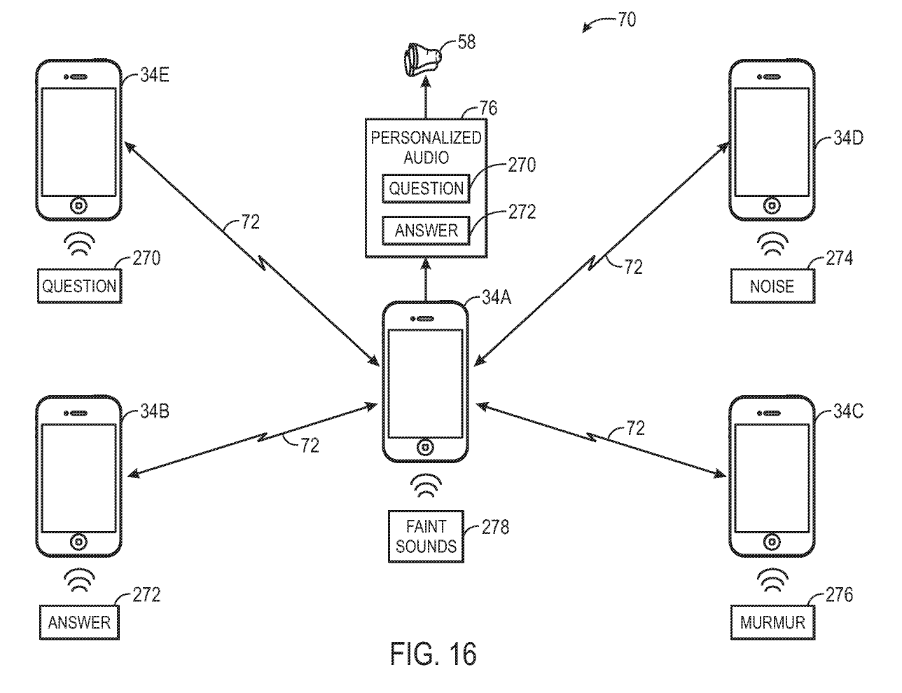

As noted above, the handheld device 34A may determine the personalized audio stream 76 based on certain user preferences. In an example illustrated in FIG. 17, a series of user preference screens may allow a user to indicate how such a handheld device 34A should determine the personalized audio stream 76. An initial user preferences screen 290 may include selectable buttons 292 and 294, respectively labeled, “Adjust Levels” and “Select Preferred Audio Sources.” A checkbox 296 may allow the user of the handheld device 34A to save preferences according to the user's current location. That is, when the checkbox 296 is selected, settings input by the user may be used automatically at a later time when the user returns to the same general location (e.g., the lecture hall 90).

By selecting the selectable button 292 labeled “Adjust Levels,” the handheld device 34A may display a screen 298 to allow the user to adjust volume levels of individual audio streams from audio streams received by the audio-sharing network 70. In the example of FIG. 17, a selectable button 300 labeled “Manual” on the screen 298 may allow a user to manually adjust the volume levels of audio streams received over the audio-sharing network 70. A selectable button 302 labeled “Automatic” may cause the handheld device 34A to automatically mix the audio streams received over the audio-sharing network 70 to produce the personalized audio stream 76 according to certain preferences.

Such automatic audio mixing preferences may include, for example, those appearing on a screen 304, which may be displayed when the selectable button 302 is selected. The screen 304 may provide a variety of options 306 to automatically adjust the volume levels of individual audio streams received over the audio-sharing network 70. It should be appreciated that these audio processing options 306 are not intended to be exhaustive or mutually exclusive. For example, selecting a first option 306 labeled “Threshold” may cause the handheld device 34A to include an individual audio stream received from the audio-sharing network 70 only when the received audio stream exceeds a threshold volume level. For example, in the context of the university lecture hall 90 example of FIGS. 15 and 16, the question 270 and the answer 272 may have a volume level that exceeds a threshold, while the noise 274, murmur 276, and the faint sounds 278 may have a volume level that does not exceed the threshold. Under such conditions, when the first option 306 is selected, the handheld device 34A may substantially only combine the audio streams including the question 270 (e.g., from the handheld device 34E) and the answer 272 (e.g., from the handheld device 34B) to produce the personalized audio stream 76.

A second option 306, labeled “Use Moderator Settings,” may cause the handheld device 34A to use settings determined by the moderator of the audio-sharing network 70, if the audio-sharing network 70 has a designated moderator. For example, the moderator of the audio-sharing network 70 may select which of the member devices of the audio-sharing network 70 are to provide audio to the other member devices. By way of example, as discussed below, a moderator such as the lecturer 92 may selectively mute all other member devices other than the handheld device 34B, and/or may choose to mute or unmute only certain other members of the audio-sharing network 70. A moderating electronic device 10 may provide digital audio control instructions to cause other members of the audio-sharing network 70 to share or not to share ambient audio with the audio-sharing network 70.

A third option 306, labeled “Priority to Nearest,” may cause the handheld device 34A to emphasize (e.g., amplify or include) audio streams received by nearby members of the audio-sharing network 70 and to deemphasize (e.g., attenuate or exclude) those more distant. In the university lecture hall 90 example of FIG. 15, using the third option 306 may cause the handheld device 34A to emphasize audio from the handheld device 34B and/or 34C and/or to deemphasize audio received from the handheld devices 34D and/or 34E. In some embodiments, the third option 306 may read “Priority to Nearest Moderator(s),” and may cause the handheld device 34A to emphasize audio streams received by nearby moderators of the audio-sharing network 70 and to deemphasize all others to some degree.

A fourth option 306, labeled “Determine Primary Speakers,” may cause the handheld device 34A to emphasize audio streams from the audio-sharing network 70 that appear to include audio from the primary speakers of a conversation taking place in the vicinity of the audio-sharing network 70. The handheld device 34A may determine that a received audio stream includes a primary speaker based at least partly, for example, on the volume level of such an audio stream. In the context of the university lecture hall 90 example of FIGS. 15 and 16, when the fourth option 306 has been selected, the handheld device 34A may determine that audio streams from the handheld device 34B, which includes audio belonging to the lecturer 92, includes audio from a primary speaker of the current conversation. The handheld device 34A may make such a determination because the volume level of the audio stream from the handheld device 34B may be consistently higher than the audio streams from the other handheld devices 34A, 34C, 34D, and/or 34E. A fifth option 306, labeled “Use Settings of Nearby Members,” may allow the user of the handheld device 34A to use the preferences set by users of the audio-sharing network 70 located nearby, as may be determined based on location identifying data.

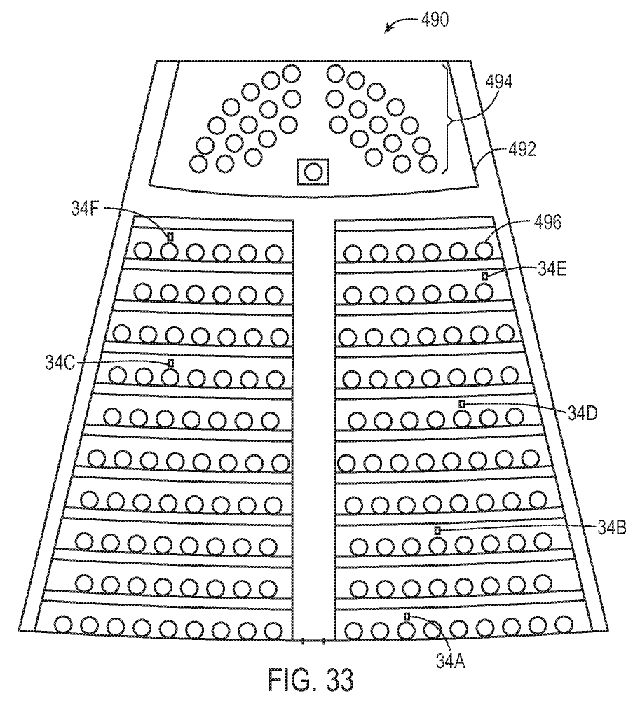

A sixth option 306, labeled “Content-Based Filtering,” may cause the handheld device 34A to emphasize or deemphasize the various audio streams from the audio-sharing network 70 depending on the content of the audio present. By way of example, such content-based filtering may form the personalized audio stream 76 by emphasizing audio streams that include certain words, such as the name of the user or words that the user is likely to find of interest or has indicated that are of interest, while deemphasizing audio streams that do not include those words. To do so, the handheld device 34A may analyze the incoming audio streams for the presence of such words, emphasizing those audio streams in which the words are found. Additionally or alternatively, the content-based filtering may emphasize audio streams containing music while deemphasizing audio streams containing words, or vice-versa. The emphasis of music over words may be useful, for example, in a concert context discussed further below with reference to FIG. 33.

Selecting the sixth option 306 labeled “Content-Based Filtering” may cause the handheld device 34 to display a screen 307 in some embodiments. As shown in the screen 307 of FIG. 17, a user may specify what content should be included or emphasized (numeral 308) in the personalized audio stream 76, such as music and/or words. A user may further specify which words are of interest to the user. In certain embodiments, a user may specify what content should be excluded or deemphasized (numeral 309) in the personalized audio stream 76. That is, the user may indicate whether music and/or words should be excluded or deemphasized. The screen 307 may allow the user to specify certain words that are not of interest.

Additionally or alternatively, as illustrated in FIG. 18, by selecting the selectable button 294, labeled “Select Preferred Audio Sources,” on the screen 290, a user may select particular members of the audio-sharing network 70 as preferred audio sources. That is, when a user selects the selectable button 294, the handheld device 34A may display a screen 310, presenting the various members of the audio-sharing network 70 in a selectable list 312. The selectable list 312 may allow the user to select particular members of the audio-sharing network 70 from which to receive audio streams. Additionally or alternatively, the handheld device 34A may receive all of the audio streams that are provided by the other member electronic devices 10 of the audio-sharing network, but to emphasize or deemphasize the audio streams as selected on the selectable list 312. It should be noted that these preferences may be shared among the various member electronic devices 10 of an audio-sharing network 70 as audio control information. Such audio control information may be used by such member electronic devices 10 to determine whether to obtain and/or share ambient audio with the audio-sharing network 70. For example, if the audio control information indicates that some threshold of member electronic devices 10 of an audio-sharing network 70 (e.g., handheld devices 34A, 34B, 34C, and 34D) do not prefer ambient audio from a particular member electronic device 10 (e.g., handheld device 34E), that member electronic device 10 (e.g., handheld device 34E) may stop obtaining or sending ambient audio to the audio-sharing network 70.

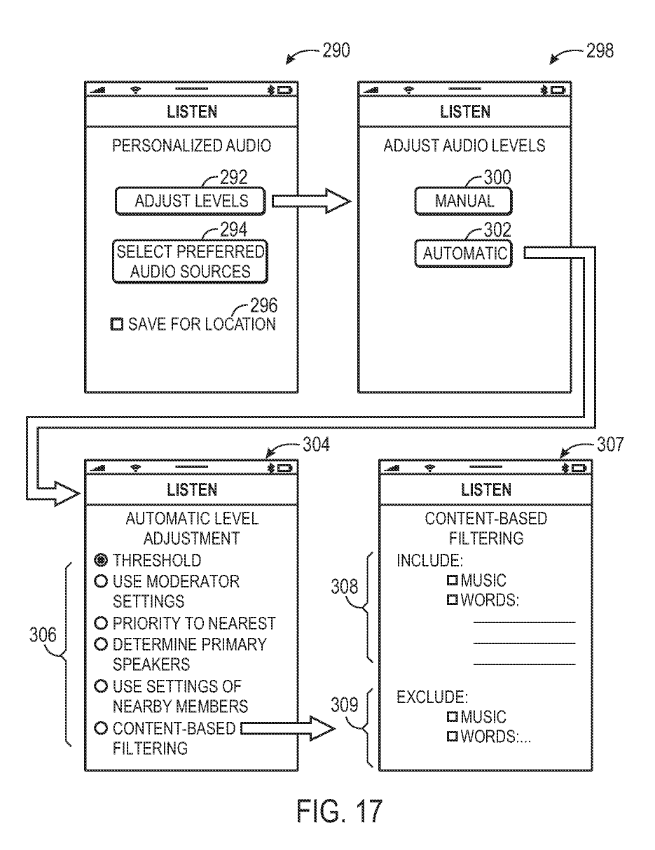

As mentioned above, if the audio-sharing network 70 includes a moderator, the moderating electronic device 10 (e.g., the handheld device 34B belonging to the lecturer 92) may control which members of the audio-sharing network 70 provide audio to other members of the audio-sharing network 70, as shown in FIG. 19. FIG. 19 illustrates a screen 320 that may display moderator settings. The screen 320 may enable the moderator to control which members of the audio-sharing network 70 provide audio to other members of the audio-sharing network 70. In the example of FIG. 19, the screen 320 includes a selectable button 322, labeled “Mute All Other Devices,” and a selectable button 324, labeled “Mute Selected Devices.” By selecting the selectable button 322 labeled “Mute All Other Devices,” the moderator may choose to cause all other members of the audio-sharing network 70 than the moderating electronic device 10 (e.g., the handheld device 34B belonging to the lecturer 92). By selecting the selectable button 324 labeled “Mute Selected Devices,” the moderator may decide which of the members of the audio-sharing network 70 are muted or provide audio to the audio-sharing network 70. Using the university lecture hall 90 example of FIG. 15, the lecturer 92 may be the moderator who decides to selectively unmute the handheld device 34E in this way, while muting the handheld devices 34A, 34C, and/or 34D. Thus, the handheld device 34E may provide the audio stream that includes the question 272 to the audio-sharing network 70. At the same time, the handheld devices 34A, 34C, and/or 34D may not provide audio streams that include the noise 274, murmur 276, or faint sounds 278 to the audio-sharing network 70.

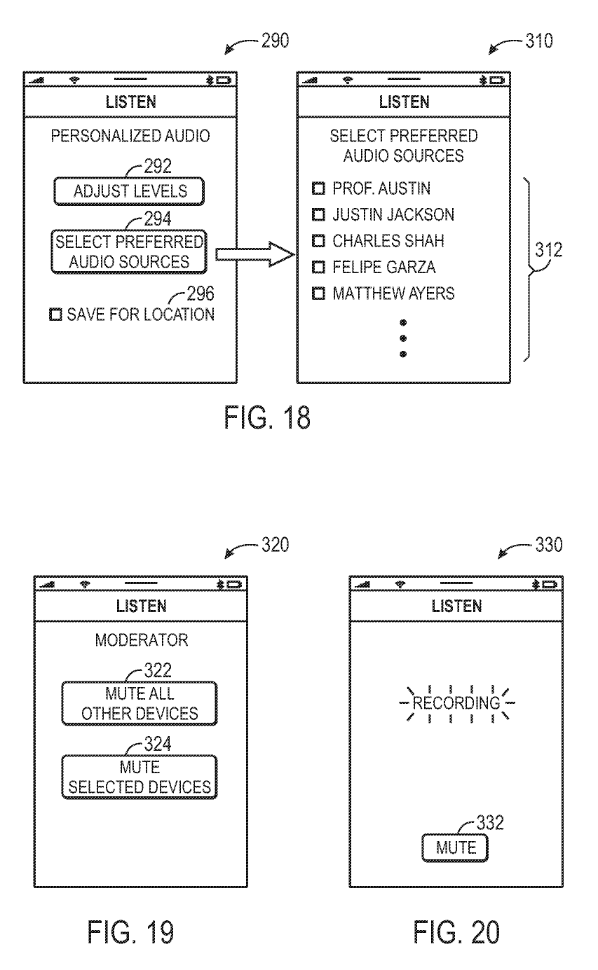

Additionally or alternatively, individual member electronic devices 10 of the audio-sharing network 70 may selectively provide audio to the audio-sharing network 70. For example, as shown by a screen 330 of FIG. 20, an electronic device 10 that is a member of the audio-sharing network 70 may, in some embodiments, provide audio to the audio-sharing network 70 unless the user of that electronic device 10 selects a selectable button 332 labeled “Mute.” That is, when the selectable button 332 is selected, the electronic device 10 may not provide audio to the audio-sharing network 70, but still may receive audio from the audio-sharing network 70. By way of example, in the context of the university lecture hall 90 setting example of FIGS. 15 and 16, users may select the selectable button 332 to mute their respective handheld devices 34A, 34C and/or 34D while the lecturer 92 is speaking or when the student 94 is asking the question 272. In this way, the handheld devices 34A, 34C, and/or 34D may not provide audio streams that include the noise 274, murmur 276, or faint sounds 278 to the audio-sharing network 70.

In another embodiment, a handheld device 34 that is a member of the audio-sharing network 70 may provide audio to the audio-sharing network 70 while the handheld device 34 is facing upward, but not when the handheld device 34 is rotated to face flat downward, as shown in FIG. 21. As shown in FIG. 21, while the handheld device 34 is lying flat, facing upward, the orientation-sensing circuitry 30 may indicate to the handheld device 34 of this orientation. While so orientation, the handheld device 34 may obtain and/or provide the audio stream to the audio-sharing network 70. The handheld device 34 also may display a screen 340 indicating that audio is being provided to the audio-sharing network 70 while the display is active. When a user rotates 342 the handheld device 34, causing the handheld device 34 to face downward, this rotation and change in orientation may be detected by the orientation-sensing circuitry 30. While the handheld device 34 is facing downward as shown, the handheld device 34 may mute 344 the handheld device 34, causing the handheld device 34 not to provide audio to the audio-sharing network 70.

In another embodiment, as shown in FIG. 22, a handheld device 34 that is a member of the audio-sharing network 70 may remain muted, not providing audio to the audio-sharing network 70, unless the handheld device 34 is picked up and/or moved by its user. That is, when the user is merely listening or otherwise not participating in a conversation taking place over the audio-sharing network 70, and the handheld device 34 is not moving, as detected by the orientation-sensing circuitry 30, the handheld device 34 may not obtain and/or provide audio to the audio-sharing network 70. The handheld device 34 may also display a screen 350 indicating that the handheld device 34 is not providing audio to the audio-sharing network 70 while the display is active. When the user picks up 352 the handheld device 34, the orientation-sensing circuitry 30 may detect this movement. Since the user is likely to pick up 352 the handheld device 34 when asking a question or otherwise participating in a conversation associated with the audio-sharing network 70, when the user picks up 352 the handheld device 34, the handheld device 34 may obtain and/or provide audio to the audio-sharing network 70. The handheld device 34 may also display a screen 340 indicating the same.

A user may keep the handheld device 34 in a pocket, away from the light, when it is not in use. Accordingly, in some embodiments, the handheld device 34 that is a member of the audio-sharing network 70 may remain muted 361 while in a user's pocket, as shown in FIG. 23. When the user removes the handheld device 34 from the user's pocket 360 (e.g., to ask a question or otherwise participate in a conversation), the ambient light sensor 20 of the handheld device 34 may detect light 362. When the quantity of light 362 exceeds a threshold, indicating that the handheld device 34 is no longer ensconced in a pocket, the handheld device 34 may begin to obtain and/or provide audio to the audio-sharing network 70. The handheld device 34 may also display the screen 340, indicating that the handheld device is now obtaining such audio.

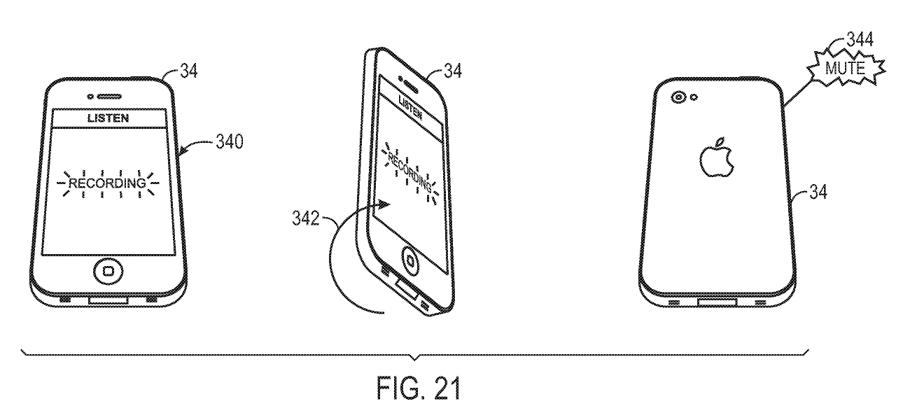

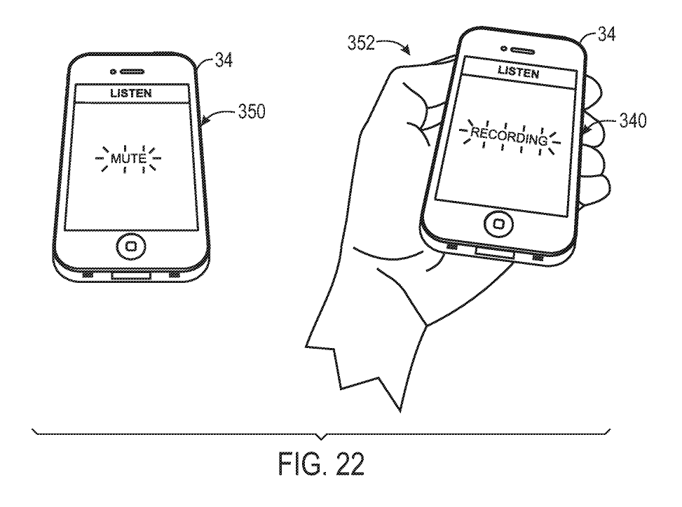

As noted above, individual member electronic devices 10 of the audio-sharing network 70 may provide audio to the audio-sharing network 70 depending on the user's behavior. In some embodiments, the automatically determine whether to provide audio based, for example, on ambient sounds that are detected by the electronic device 10. For example, as shown in FIG. 24, a handheld device 34 that is a member of an audio-sharing network 70 may automatically mute or unmute depending on the audio that is detected by the handheld device 34. In the example of FIG. 24, a handheld device 34 may display a screen 370 having a rocker switch 372 that allows a user to select an auto-mute mode. When the rocker switch 372 is selected, the handheld device 34 may not constantly obtain and/or transfer audio to the audio-sharing network 70, as described by a flowchart 380 of FIG. 25.

The flowchart 380 may begin as the handheld device 34 is not currently sending audio to the audio-sharing network 70 (block 382). Rather, the handheld device 34 may periodically sample ambient audio from its microphone 32 (block 384). The handheld device 34 may determine whether the sampled ambient audio is of interest (decision block 386), and if it is not, the handheld device 34 may continue not to send audio to the audio-sharing network 70 (block 382). If the sampled ambient audio is of interest (decision block 386), the handheld device 34 may begin sending the audio to the audio-sharing network 70 (block 388).

Whether the sampled ambient audio is of interest may depend on a variety of factors. For example, the handheld device 34 may determine that sampled ambient audio is of interest if the volume level of the ambient audio exceeds a threshold, or seems to include a human voice. In some embodiments, the handheld device 34 may determine that the sampled ambient audio is of interest when the ambient audio includes certain words, such as a name of a user whose electronic device 10 is a member of the audio-sharing network 70. Additionally or alternatively, the handheld device 34 may determine that the sampled ambient audio is of interest when the ambient audio contains certain frequencies or patterns that may be of interest to other users participating in the audio-sharing network 70.

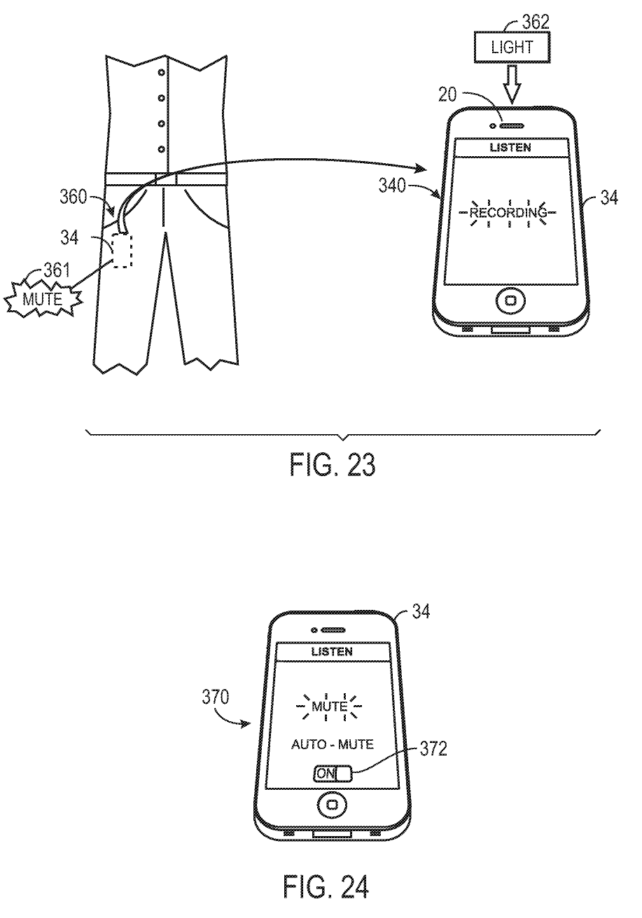

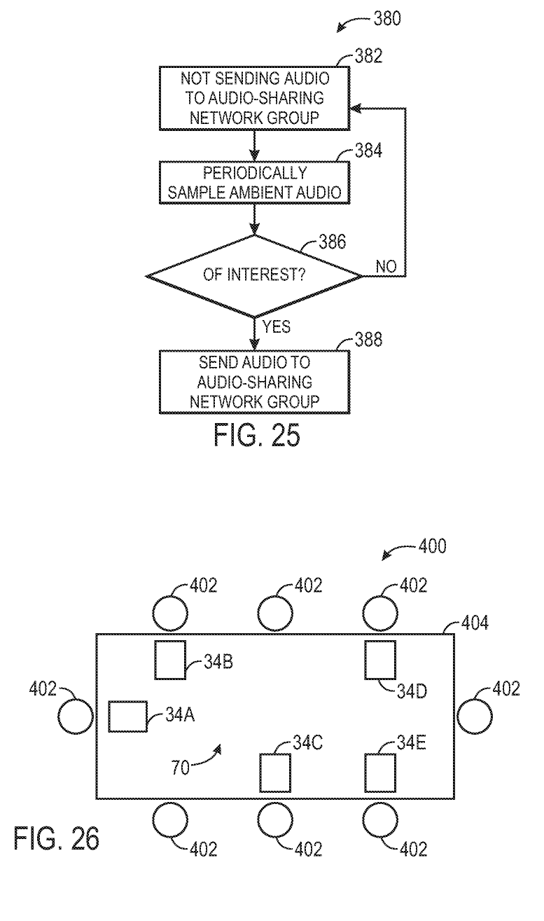

An audio-sharing network 70 also may be employed in other contexts, including the context of a restaurant 400 setting, as shown in FIG. 26. In the example of FIG. 26, restaurant goers 402 are seated around a table 404 in a restaurant 400. Some of the restaurant goers 402 have placed their own personal electronic devices 10 on the table 404 in front of them, here shown as handheld devices 34A, 34B, 34C, 34D, and/or 34E. These handheld devices 34A, 34B, 34C, 34D, and/or 34E may join together in an audio-sharing network 70 using, for example, any or all of the techniques described above. Because the restaurant goers 402 are seated relatively nearby to one another, the restaurant goers 402 may initiate or join the audio-sharing network 70 by tapping their handheld devices 34 together, as shown in FIG. 27.

In the example shown in FIG. 27, a user may select the selectable button 114 on the screen 112 to join an audio-sharing network 70 in the vicinity. As shown on the screen 150, which may be displayed on the handheld device 34, the user may select a selectable button 152 to join an audio-sharing network 70 in the manners discussed above or may select a selectable button 154 to join the same or another local audio-sharing network 70 by simply tapping their handheld devices 34 together. That is, when a user, such as a restaurant goer 402, selects the selectable button 154, their handheld devices 34 may display a screen 410. The screen 410 may invite the user to tap their handheld device 34 to another handheld device 34. In the example of FIG. 26, the handheld device 34A may be tapped to the handheld device 34B, allowing the handheld device 34A to join the audio-sharing network 70 to which the handheld device 34B is a member. It should be noted that by tapping the electronic devices 10 together in this way, the audio-sharing network 70 may be certain that both electronic devices 10 are in the vicinity of one another.

Turning to FIG. 28, when one handheld device 34 is tapped to another handheld device 34 in this manner, a prospective joining electronic device (e.g., handheld device 34A) may display a pop-up box 420 asking the restaurant goer 402 to join the audio-sharing network 70. By way of example, the pop-up box 420 may include a selectable button 422 labeled “Join” and a selectable button 424 labeled “Close”. Selecting the selectable button 422 labeled “Join” may allow the handheld device 34 to join the audio-sharing network 70.

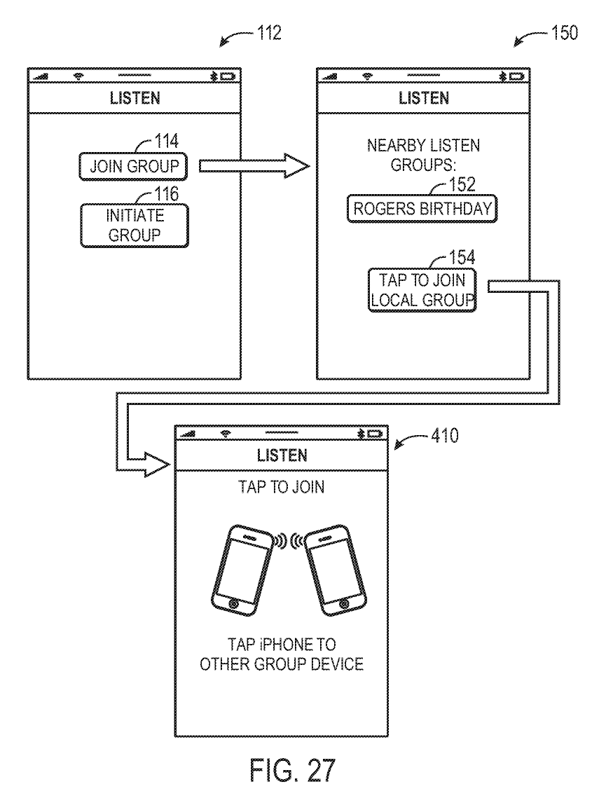

In the context of the restaurant 400 setting, many of the members of the audio-sharing network 70 may pick up noise while only some of the members of the audio-sharing network 70 may pick up audio that is pertinent to the listeners of the audio-sharing network 70. For example, as shown in FIG. 29, the table 404 may be surrounded by restaurant noise 430. Such noise 430 may be picked up by the handheld devices 34A, 34B, 34C, 34D, and/or 34E. Pertinent audio 432 may substantially be detected only by certain electronic devices 10, here shown to be the handheld devices 34D and 34E as indicated by a numeral 434.

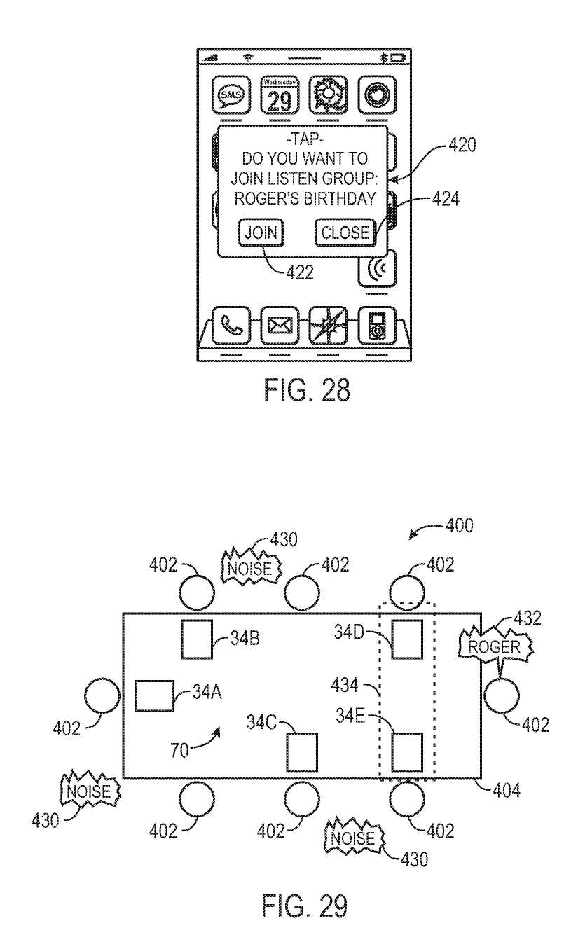

Despite the presence of the noise 430, a member electronic device 10 (e.g., handheld device 34A) of the audio-sharing network 70 may determine a personalized audio stream 76 that may have reduced noise, as shown by a flowchart 440 of FIG. 30. In the flowchart 440, a member of the audio-sharing network 70, such as the handheld device 34A, may receive audio from other members of the audio-sharing network 70, such as the handheld devices 34B, 34C, 34D, and/or 34E (block 442). The handheld device 34A may determine which of the audio streams it has received are likely pertinent to the conversation taking place over the audio-sharing network 70 (block 444). As discussed above, the handheld device 34A may determine that which of the audio streams contain pertinent audio based at least partly, for example, on whether the volume level of the audio stream exceeds a threshold, or seems to include a human voice. The handheld device 34A may determine which audio streams contain pertinent audio when the audio stream includes certain words, such as a name of a user whose electronic device 10 is a member of the audio-sharing network 70 (e.g., “Roger”). Additionally or alternatively, the handheld device 34 may determine which of the audio streams contain pertinent audio when the audio stream contains certain frequencies or patterns that may be of interest to other users participating in the audio-sharing network 70.

When the pertinent audio stream(s) (e.g., audio streams from the handheld devices 34D and/or 34E) have been identified, the handheld device 34A may use the audio streams obtained from the other members of the audio-sharing network 70 as a basis for noise reduction (block 446). The handheld device 34A then may determine the personalized audio stream 76 by applying any suitable noise reduction technique to the pertinent audio streams using the other audio streams a basis for noise reduction (block 448). The handheld device 34A may transmit this personalized audio stream 76 to one or more personal listening devices, such as hearing aids 58 (block 450).

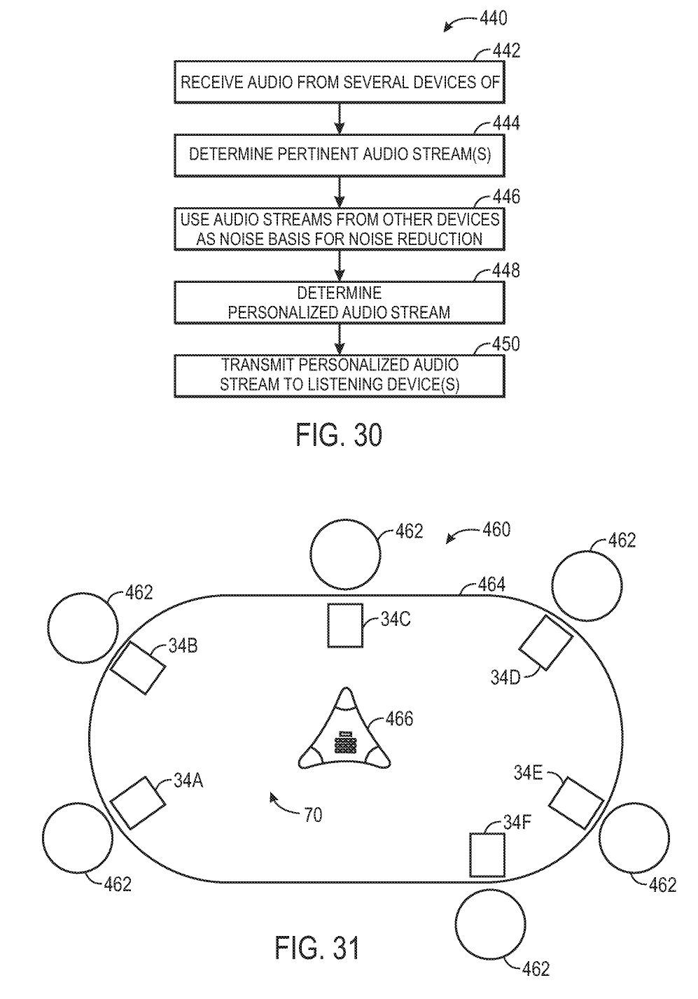

An audio-sharing network 70 may also be employed in the context of a teleconference 460, as shown in FIG. 31. In the example of FIG. 31, the teleconference 460 may include several conferees 462 seated around a conference table 464. Some or all of the conferees 462 may have personal electronic devices 10, such as the handheld devices 34A, 34B, 34C, 34D, 34E and/or 34F, placed before them on the conference table 464. An audio-sharing network 70 may be formed from among those devices 34A-F and a conference telephone 466 or any other suitable teleconferencing device, which may represent one embodiment of the electronic device 10.

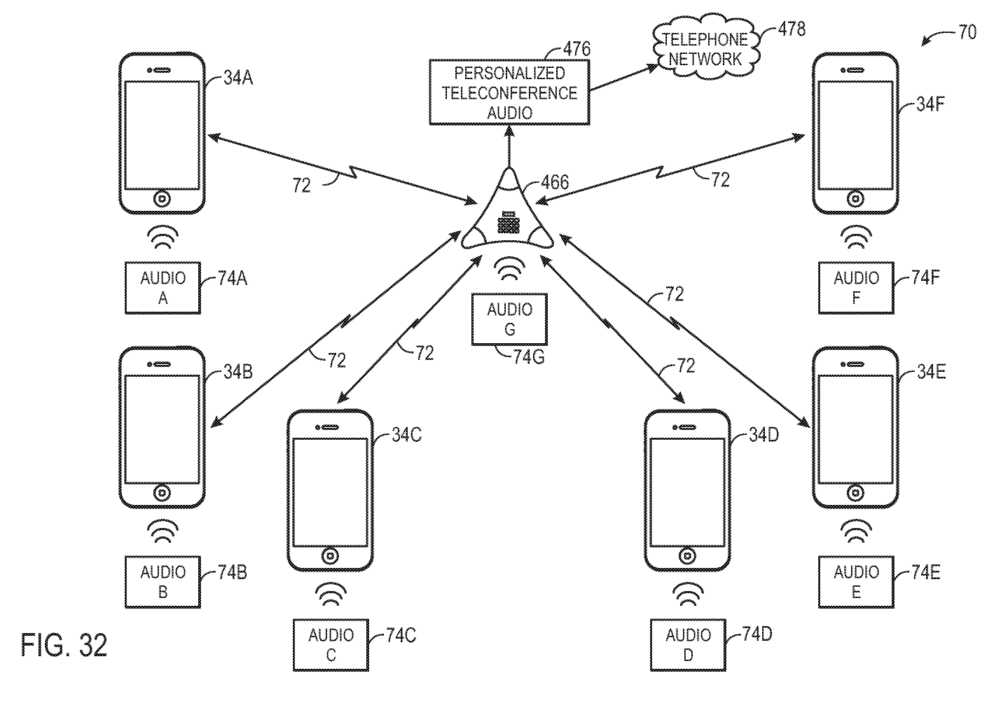

As represented by a schematic diagram illustrated in FIG. 32, each of the handheld devices 34A, 34B, 34C, 34D, 34E and/or 34F may respectively obtain audio streams 74A, 74B, 74C, 74D, 74E, and/or 74F, which may be provided to the conference telephone 466. The conference telephone 466 may obtain a personalized teleconference audio stream 476 in the manner described above with reference to the personalized audio 76. This personalized teleconference audio stream 476 may be provided to another party to the teleconference via a telephone network 478. As should be appreciated, the telephone network 478 may or may not be a traditional telephone network. Indeed, in some embodiments, the telephone network 478 may be the Internet and the personalized audio stream 476 may be provided as voice over Internet protocol (VOIP), for example.

An audio-sharing network 70 may also be used in the context of a concert hall 490 setting, as shown in FIG. 33. In FIG. 33, the concert hall 490 includes a stage 492, upon which performers 494 may be generating sounds (e.g., music or speech). Various personal electronic devices 10 held by audience members 496 (e.g., handheld devices 34A, 34B, 34C, 34D, 34E and/or 34F) may form an audio-sharing network 70 to capture audio from the performers 494. Because the obtained by the handheld devices 34A, 34B, 34C, 34D, 34E and/or 34F of the audio-sharing network 70 may capture music at various distances and/or orientations from the stage 492, audio shared by the audio-sharing network 70 may be used to obtain a stereo or multi-dimensional audio recording of a concert or event. Specifically, the relative or absolute position of the handheld devices 34A, 34B, 34C, 34D, 34E and/or 34F may be detectable by their respective location-sensing circuitry 22. By mixing the audio streams using any suitable surround-sound technique according to their relative locations from an audio source (e.g., relative to the stage 492) or their relative locations to one another, surround-sound audio may be obtained and/or recorded.

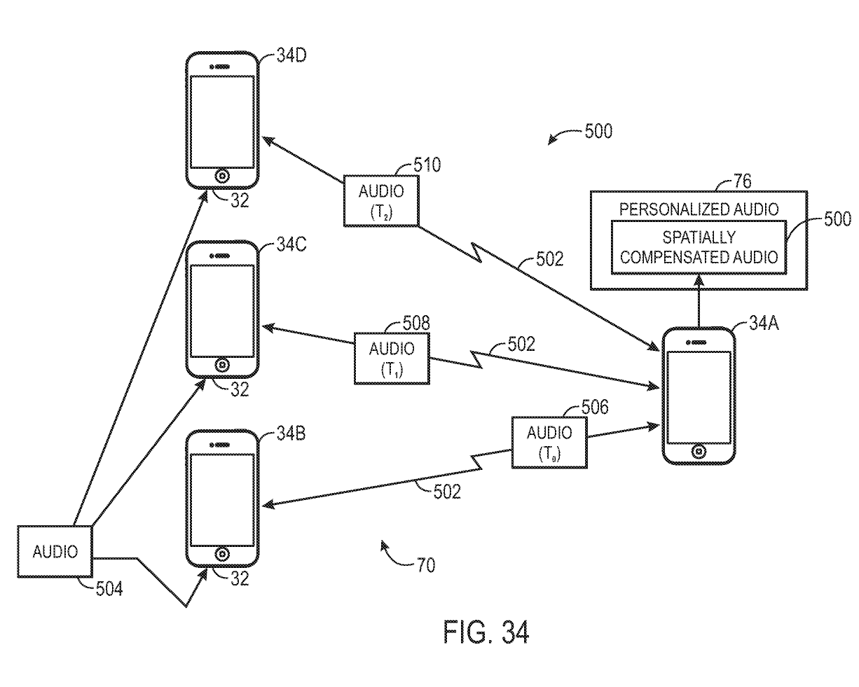

Indeed, an audio-sharing network 70 may be used to generate a personalized audio stream 76 that includes spatially compensated audio 500, as illustrated in FIG. 34. In the example of FIG. 34, the handheld devices 34B, 34C, and/or 34D detect audio that derives from a common audio source 504. Since the handheld devices 34B, 34C, and 34D are located different respective distances from the common audio source 504, however, they may detect the audio from the common audio source at different times. Accordingly, sounds from the common audio source 504 may be obtained at a time T₀ by the handheld device 34B and transmitted as an audio stream 506. Sounds from the common audio source 504 may reach the handheld device 34C at a later time, and thus the handheld device 34C may transmit a second audio stream 508 obtained at a later time T₁. Sounds from the common audio source 504 may reach the handheld device 34D at a still later time, and thus the handheld device 34D may transmit a third audio stream 510 obtained at a still later time T₂.

These audio streams 506, 508, and 510 may be received by the handheld device 34A. If the handheld device 34A simply combined all of the audio streams 506, 508, and 510, the original audio 504 might become muddled because each of the handheld devices 34B, 34C, and/or 34D detected the sounds from the common audio source 504 at a slightly different time. To prevent such muddling from happening, the handheld device 34A may determine that the audio streams 506, 508, and 510 are related but were captured at different points in time. Thereafter, the handheld device 34A may appropriately shift the audio streams 506, 508, and 510 by suitable amounts of time when combining these streams to obtain the personalized audio stream 76. By way of example, the handheld device 34A may ascertain that similar patterns occur in each of the audio streams 506, 508, and 510 at specific amounts of time apart from one another. In another example, the handheld device 34A may estimate how to shift the timing of the audio streams 506, 508, and 510 based on location identifying data respectively associated with the handheld devices 34B, 34C, and 34D. If the location of the common audio source 504 is known (e.g., the stage 492), the handheld device 34A may shift the timing of the audio streams 506, 508, and 510 based on the respective distances of the handheld devices 34B, 34C, and 34D from the common audio source 504.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. An electronic device comprising:
a microphone configured to obtain ambient audio and produce a digital ambient audio signal representative of the ambient audio, wherein at least some of the ambient audio is also detectable by a microphone of another electronic device that is a member of an audio-sharing network;
a network interface configured to connect to the audio-sharing network via a local wireless network and to provide the digital ambient audio signal to the audio-sharing network; and
data processing circuitry configured to control when the microphone obtains the ambient audio and when the network interface provides the digital ambient audio signal to the audio-sharing network.

2. The electronic device of claim 1, wherein the network interface is configured to receive audio control instructions from a moderating electronic device of the audio-sharing network, wherein the data processing circuitry is configured to control when the microphone obtains the ambient audio or when the network interface provides the digital ambient audio signal to the audio-sharing network, or both, based at least in part on the audio control instructions.

3. The electronic device of claim 1, wherein the network interface is configured to receive audio control information from one or more other electronic devices that are members of the audio-sharing network, wherein the audio control information indicates whether the one or more other electronic devices that are members of the audio-sharing network find the ambient audio from the electronic device to be of interest, wherein the data processing circuitry is configured to control when the microphone obtains the ambient audio or when the network interface provides the digital ambient audio signal to the audio-sharing network, or both, based at least in part on the audio control information.

4. The electronic device of claim 1, comprising orientation-sensing circuitry configured to indicate an orientation of the electronic device, wherein the data processing circuitry is configured to control when the microphone obtains the ambient audio or when the network interface provides the digital ambient audio signal to the audio-sharing network, or both, based at least in part on the orientation of the electronic device.

5. The electronic device of claim 1, comprising orientation-sensing circuitry configured to indicate an orientation of the electronic device, wherein the data processing circuitry is configured to control when the microphone obtains the ambient audio or when the network interface provides the digital ambient audio signal to the audio-sharing network, or both, based at least in part on whether the orientation of the electronic device is changing or has changed recently within a given amount of time.

6. The electronic device of claim 1, comprising an ambient light sensor configured to detect ambient light, wherein the data processing circuitry is configured to control when the microphone obtains the ambient audio or when the network interface provides the digital ambient audio signal to the audio-sharing network, or both, based at least in part on an amount of detected ambient light.

7. The electronic device of claim 1, wherein the data processing circuitry is configured to analyze the ambient audio, determine whether the ambient audio is of interest to the audio-sharing network, and cause the network interface to provide the digital ambient audio signal to the audio-sharing network when the data processing circuitry determines the ambient audio is of interest to the audio-sharing network.

8. The electronic device of claim 7, wherein the data processing circuitry is configured to determine whether the ambient audio is of interest to the audio-sharing network based at least in part on a volume level of the ambient audio, a frequency of the ambient audio, a voice discernable in the ambient audio, a word discernable in the ambient audio, or a name discernable in the ambient audio, or any combination thereof.

9. The electronic device of claim 7, wherein the data processing circuitry is configured to cause the microphone only to obtain the ambient audio periodically unless the data processing circuitry determines the ambient audio is of interest to the audio-sharing network.

10. A system comprising:
a personal electronic device configured to join an audio-sharing network, to receive a plurality of digital audio streams from the audio-sharing network, to determine a digital user-personalized audio stream based at least in part on at least a subset of the plurality of digital audio streams, and to output the digital user-personalized audio stream.

11. The system of claim 10, wherein the personal electronic device comprises a personal desktop computer, a personal notebook computer, a personal tablet computer, a personal handheld device, a portable media player, a portable phone, or a teleconferencing device, or a combination thereof.

12. The system of claim 10, wherein the personal electronic device is configured to determine the digital user-personalized audio stream by including in the digital user-personalized audio stream any of the plurality of digital audio streams that exceed a threshold volume level or excluding in the digital user-personalized audio stream any of the plurality of digital audio streams that do not exceed the threshold volume level, or doing both.

13. The system of claim 10, wherein the personal electronic device is configured to determine the digital user-personalized audio stream by emphasizing one or more of the plurality of digital audio streams that exceed a threshold volume level or deemphasizing one or more of the plurality of digital audio streams that do not exceed the threshold volume level, or doing both.

14. The system of claim 10, wherein the personal electronic device is configured to determine the digital user-personalized audio stream based at least in part on settings selected by a moderating electronic device of the audio-sharing network.

15. The system of claim 10, wherein the personal electronic device is configured to determine the digital user-personalized audio stream by prioritizing one of the plurality of digital audio streams over another based at least in part on locations of member devices of the audio-sharing network that supplied the one of the plurality of digital audio streams or the other.

16. The system of claim 10, wherein the personal electronic device is configured to determine whether one of the plurality of digital audio streams includes or is likely to include audio belonging to a speaker in a conversation that is detectable to the audio-sharing network and to determine the digital user-personalized audio stream by emphasizing the one of the plurality of digital audio streams when the one of the plurality of digital audio streams is determined to include audio belonging to the speaker.

17. The system of claim 10, wherein the personal electronic device is configured to determine the digital user-personalized audio stream by emphasizing audio streams of the plurality of digital audio streams that derive from user-preferred member devices of the audio-sharing network.

18. The system of claim 10, wherein the personal electronic device is configured to determine the digital user-personalized audio stream by emphasizing audio streams of the plurality of digital audio streams that contain specified content.

19. The system of claim 10, comprising a personal listening device associated with the personal electronic device, wherein the personal listening device is configured to receive the digital user-personalized audio stream and to play out an analog representation of the digital user-personalized audio stream.

20. The system of claim 19, wherein the personal listening device comprises a wireless hearing aid, a wired hearing aid, a speaker of the electronic device, an external speaker, a cochlear implant, a wireless headset, or a wired headset, or a combination thereof.

21. An electronic device comprising:
a microphone configured to obtain ambient audio and produce a digital ambient audio signal representative of the ambient audio;
data processing circuitry configured to determine location identifying data that indicates whether the electronic device is expected to be within range of detecting sounds also detectable by one or more other electronic devices that share audio obtained by the one or more of the other electronic devices; and
a network interface configured to connect to the one or more of the other electronic devices, provide the location identifying data, and share the digital ambient audio signal with the other electronic devices when the location identifying data indicates that the electronic device is expected to be within range of detecting the sounds also detectable by the one or more other electronic devices.

22. The electronic device of claim 21, wherein the location identifying data comprises a sample of the digital ambient audio signal associated with an indication of a time that the ambient audio was obtained by the microphone, wherein the location identifying data indicates that the electronic device is located within range of detecting sounds also detectable by one or more of a plurality of other electronic devices when the ambient audio comprises the sounds also detectable by the one or more of the plurality of other electronic devices.

23. The electronic device of claim 21, wherein the network interface is configured to receive the digital audio obtained by the one or more of the other electronic devices, wherein the data processing circuitry is configured to compare the digital audio obtained by the one or more other electronic devices and the digital ambient audio signal and to cause the network interface to share the digital ambient audio signal with the other electronic devices when the digital ambient audio signal and the digital audio obtained by the one or more other electronic devices both include the sounds also detectable by the one or more other electronic devices.

24. The electronic device of claim 21, comprising location-sensing circuitry configured to detect a geophysical location of the electronic device, wherein the location identifying data comprises the geophysical location of the electronic device and wherein the geophysical location of the electronic device is within a specified boundary.

25. The electronic device of claim 21, comprising location-sensing circuitry configured to detect a geophysical location of the electronic device, wherein the location identifying data comprises the geophysical location of the electronic device and wherein the geophysical location of the electronic device is within a threshold distance from at least one of the other electronic devices.

26. The electronic device of claim 21, comprising image capture circuitry configured to obtain an image, wherein the location identifying data comprises the image and wherein the image represents a scene that is detectable by at least one of the other electronic devices.

27. The electronic device of claim 21, wherein the network interface comprises a near field communication interface configured to connect to the one or more of the other electronic devices via near field communication, wherein the location identifying data comprises an indication that the electronic device is located within range to communicate via near field communication.

28. An article of manufacture comprising:
one or more tangible, machine-readable storage media having instructions encoded thereon for execution by a processor of an electronic device, the instructions comprising:
instructions to receive communication from another electronic device via a network interface of the electronic device, wherein the communication comprises a request to join an audio-sharing network of which the electronic device is a member;
instructions to cause a microphone of the electronic device to obtain a first digital sample of ambient audio;
instructions to receive a second digital sample of ambient audio from the other electronic device via the network interface of the electronic device, wherein the second digital sample of ambient audio comprises ambient audio detected by another microphone associated with the other electronic device;
instructions to compare the first digital sample of ambient audio to the second digital sample of ambient audio; and
instructions to permit the other electronic device to join the audio-sharing network when sounds from the first digital sample of ambient audio substantially match sounds from the second digital sample of ambient audio.

29. A method comprising:
receiving a plurality of digital audio streams into an electronic device from an audio-sharing network of personal electronic devices, wherein each of the plurality of digital audio streams includes sound deriving from a common audio source and wherein each of the personal electronic devices has a different distance from the common audio source; and
processing the plurality of digital audio streams into audio that compensates for spatial differences between the personal electronic devices and the common audio source.
